(19) United States
(12) Patent Application Publication
(10) Pub. No.: US 2026/0230241 A1
(43) Pub. Date: Aug. 6, 2026

(54) COMMUNICATION DEVICE, CONTROL METHOD, AND PROGRAM

(71) Applicant: KABUSHIKI KAISHA TOSHIBA, Minato-ku, Tokyo (JP)

(72) Inventors: Masahiko SUGIMOTO, Hiratsuka Kanagawa (JP); Toshinori DOI, Suginami Tokyo (JP)

(73) Assignee: KABUSHIKI KAISHA TOSHIBA, Minato-ku, Tokyo (JP)

(21) Appl. No.: 19/152,077

(22) PCT Filed: Jan. 23, 2024
(86) PCT No.: PCT/JP2024/001804

§ 371 Date: Jul. 30, 2025

(30) Foreign Application Priority Data
Jan. 31, 2023 (JP) 2023-013363

(51) Int. Cl. H04L 5/00; H04L 27/26; H04W 76/40

(52) U.S. Cl. CPC H04L 5/0007; H04L 27/265; H04W 76/40

(57) ABSTRACT

In a communication device according to an embodiment, a processor receives an OFDM signal and converts the OFDM signal into a baseband time-axis waveform signal.

The processor extracts a part of the time-axis waveform signal. The processor calculates a degree of similarity between the extracted part of the time-axis waveform signal and a known signal. The processor converts a sampling phase of the time waveform signal based on the degree of similarity. The processor executes fast Fourier transform (FFT) on the time-axis waveform signal whose sampling phase has been converted. The processor extracts a part of a frequency-axis waveform signal obtained by the FFT. The processor calculates a degree of similarity between the extracted part of the frequency-axis waveform signal and a known signal. The processor estimates a switching timing between uplink communication and downlink communication in the communication device based on the degree of similarity.

### CROSS-REFERENCE TO RELATED APPLICATIONS

This application is national stage application of International Application No. PCT/JP 2024/001804, filed on Jan. 23, 2024, which designates the United States, incorporated herein by reference, and which claims the benefit of priority from Japanese Patent Application No. 2023-013363, filed on Jan. 31, 2023, the entire contents of which are incorporated herein by reference.

### FIELD

Embodiments described herein relate generally to a communication device, a control method, and a recording medium.

### BACKGROUND

A distributed antenna system (DAS) has been known as a form of wireless communication systems. In the distributed antenna system, communication is executed by time division duplex (TDD) in which downlink communication (DL) to be transmitted from base stations to terminals and uplink communication (UL) to be transmitted from the terminals to the base stations are switched every predetermined period of time. Such a distributed antenna system is required to detect DL periods and UL periods of radio signals and appropriately switch the DL periods and the UL periods.

In the related art, communication devices execute AD conversion for converting wireless signals from analog signals to digital signals at the beginning of a series of processes. In the AD conversion, in order to increase S/N ratios and resolutions and alleviate requirements of anti-aliasing filters, oversampling in which sampling is executed at a rate higher than a data rate of input signals is often adopted. Next, carrier frequency conversion is executed to execute frequency down-conversion on AD-converted signals and convert signals into baseband signals. Then, sampling rate conversion is executed to down-convert the sampling rate of the baseband signals from a clock frequency during AD conversion to a system clock frequency. TDD synchronization with a base station is implemented by analyzing a synchronization signal included in a signal obtained as described above and subjected to sampling rate conversion.

However, due to AD conversion and down-sampling rate conversion in a communication device, a sampling phase of a baseband time-axis waveform signal may deviate from the sampling phase during transmission.

### BRIEF DESCRIPTION OF DRAWINGS

FIG. 1 is a diagram illustrating an overall example of a distributed antenna system according to a first embodiment.

FIG. 2 is a diagram illustrating an example of a data configuration of a radio frame.

FIG. 3 is a diagram illustrating an example of an SSB displacement pattern in a radio frame.

FIG. 4 is a diagram illustrating examples of a DL/UL configuration and an SSB displacement of a TDD scheme.

FIG. 5 is a diagram illustrating an example of a functional configuration of a master station device according to the first embodiment.

FIG. 6 is a diagram illustrating an example of a functional configuration of a control unit according to the first embodiment.

FIG. 7 is a diagram illustrating an example of a functional configuration of a switching timing generation unit according to the first embodiment.

FIG. 8 is a diagram illustrating an example of a functional configuration of a PSS detection unit according to the first embodiment.

FIG. 9 is a diagram illustrating an example of a functional configuration of a phase detection unit according to the first embodiment.

FIG. 10 is a diagram illustrating an example of a functional configuration of a phase conversion unit 1014b according to the first embodiment.

FIG. 11 is a diagram 11 illustrating an example of a functional of an SSS detection unit according to the first embodiment.

FIG. 12 is a diagram illustrating an example of a functional configuration of a DMRS detection unit according to the first embodiment.

FIG. 13 is a diagram illustrating data deviating from a sampling phase during transmission using a single sine wave as an example.

FIG. 14 is a diagram illustrating data in which a sampling phase deviates in units of ¼ of a sampling period.

FIG. 15 is a diagram illustrating an example of a constellation of a frequency-axis signal obtained by executing FFT on a time-axis waveform signal using unmodulated data as an example.

FIG. 16 is a diagram illustrating an example of an I-axis waveform of a frequency-axis signal obtained by executing FFT on a time-axis waveform signal, using the same unmodulated data as an example.

FIG. 17 is a diagram illustrating an example of a constellation of frequency-axis signals obtained by executing FFT on a time-axis waveform signal using data modulated with quadrature phase shift keying (QPSK) as an example.

FIG. 18 is a diagram illustrating an example of an I-axis waveform of a frequency-axis signal obtained by executing FFT on a time-axis waveform signal using data modulated with quadrature phase shift keying (QPSK) as an example.

FIG. 19 is a flowchart illustrating an example of TDD detection processing according to the first embodiment.

FIG. 20 is a flowchart illustrating an example of time waveform processing according to the first embodiment.

FIG. 21 is a flowchart illustrating an example of sampling phase conversion processing according to the first embodiment.

FIG. 22 is a flowchart illustrating an example of phase detection processing according to the first embodiment.

FIG. 23 is a flowchart illustrating an example of phase conversion processing according to the first embodiment.

FIG. 24 is a flowchart illustrating an example of FFT processing according to the first embodiment.

FIG. 25 is a flowchart illustrating an example of frequency waveform processing according to the first embodiment.

FIG. 26 is a flowchart illustrating an example of SSS detection processing according to the first embodiment.

FIG. 27 is a flowchart illustrating an example of DMRS detection processing according to the first embodiment.

FIG. 28 is a flowchart illustrating an example of switching timing estimation processing according to the first embodiment.

FIG. 29 is a diagram illustrating an example of a constellation when there is CPE.

FIG. 30 is a diagram illustrating an example of an I-axis signal when there is CPE.

FIG. 31 is a diagram illustrating an example of a data determination result when there is CPE.

FIG. 32 is a diagram illustrating an example of a functional configuration of an SSS detection unit according to Modification 1.

FIG. 33 is a diagram illustrating an example of a functional configuration of a DMRS detection unit according to Modification 1.

FIG. 34 is a diagram illustrating an example of a constellation when there is phase rotation.

FIG. 35 is a diagram illustrating an example of an I-axis signal when there is phase rotation.

FIG. 36 is a diagram illustrating an example of a data determination result when there is a phase rotation.

FIG. 37 is a diagram illustrating an example of a constellation when there is no phase rotation.

FIG. 38 is a diagram illustrating an example of an I-axis signal when there is no phase rotation.

FIG. 39 is a diagram illustrating an example of a data determination result when there is no phase rotation.

FIG. 40 is a diagram illustrating an example of a functional configuration of a switching timing generation unit according to a second embodiment.

FIG. 41 is a diagram illustrating an example of a functional configuration of an SSS detection unit according to the second embodiment.

FIG. 42 is a diagram illustrating an example of a functional configuration of a DMRS detection unit according to the second embodiment.

FIG. 43 is a diagram illustrating an example of a differential determination result when there is no phase rotation.

FIG. 44 is a diagram illustrating an example of a differential determination result when there is CPE.

FIG. 45 is a diagram illustrating an example of a differential determination result when there is phase rotation.

### DETAILED DESCRIPTION

A communication device according to an embodiment functions as a master station device or a slave station device in a distributed antenna system and receives an orthogonal frequency division multiplexing (OFDM) signal transmitted by a time division multiplexing scheme. The distributed antenna system includes the master station device connected to a base station and one or more slave station devices relaying a signal between the master station device and a terminal device communicating with the base station. The communication device includes a hardware processor connected to a memory. The hardware processor is configured to receive the OFDM signal and convert the OFDM signal into a baseband time-axis waveform signal. The hardware processor is configured to extract a part of the time-axis waveform signal. The hardware processor is configured to calculate a degree of similarity between the extracted part of the time-axis waveform signal and a known signal. The hardware processor is configured to convert a sampling phase of the time waveform signal based on the degree of similarity. The hardware processor is configured to execute fast Fourier transform (FFT) on the time-axis waveform signal whose sampling phase has been converted. The hardware processor is configured to extract a part of a frequency-axis waveform signal obtained by the FFT. The hardware processor is configured to calculate a degree of similarity between the extracted part of the frequency-axis waveform signal and a known signal. The hardware processor is configured to estimate a switching timing between uplink communication and downlink communication in the communication device based on the degree of similarity.

A control method according to an embodiment is for a communication device functioning as a master station device or a slave station device in a distributed antenna system and receiving an orthogonal frequency division multiplexing (OFDM) signal transmitted by a time division multiplexing scheme. The distributed antenna system includes the master station device connected to a base station and one or more slave station devices relaying a signal between the master station device and a terminal device communicating with the base station. The control method includes receiving the OFDM signal and converting the OFDM signal into a baseband time-axis waveform signal. The control method includes extracting a part of the time-axis waveform signal and calculating a degree of similarity between the extracted signal and a known signal. The control method includes converting a sampling phase of the time waveform signal as the OFDM signal based on the degree of similarity to a known signal calculated. The control method includes executing fast Fourier transform (FFT) on the time-axis waveform signal obtained by the converting the sampling phase. The control method includes extracting a part of a frequency-axis waveform signal on which the FFT is executed and calculating a degree of similarity between the extracted signal and a known signal. The control method includes estimating a switching timing between uplink communication and downlink communication in the communication device based on a result of the calculating the degree of similarity.

Hereinafter, a communication device, a control method, and a recording medium will be described in detail with reference to the accompanying drawings. In the following description of each embodiment and modification, units denoted by the same reference numerals have substantially the same functions, and the description of repeated units will be omitted as appropriate.

### First Embodiment

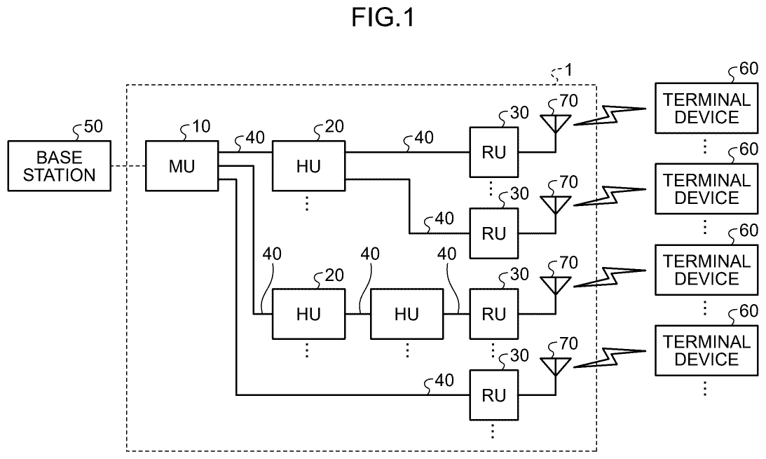

FIG. 1 is a diagram illustrating an overall example of a distributed antenna system 1 according to a first embodiment. The distributed antenna system 1 includes a master station device 10 (MU), a relay device 20 (HU), a slave station device 30 (RU), and a transmission path 40 that connects these devices. More specifically, the distributed antenna system 1 includes the master station device 10 connected to a base station 50, and one or more slave station devices 30 that relay signals between a terminal device 60 communicating with the base station 50 and the master station device 10.

The master station device 10 is connected to the slave station devices 30 inside the distributed antenna system 1. As illustrated in FIG. 1, the slave station devices 30 may be connected to the master station device 10 via the relay device 20, or a plurality of slave station devices 30 may be directly connected to the master station device 10.

As illustrated in FIG. 1, the master station device 10 may be cascade-connected to the relay device 20.

The master station device 10 is connected to the base station 50 by a coaxial cable, and transmits and receives a radio signal to and from the base station 50. Here, the wireless signal is a signal of a wireless communication band to be transmitted to the terminal device 60. The master station device 10 relays a wireless signal received from the base station 50 to the relay device 20 or the slave station device 30. The master station device 10 relays a radio signal received from the relay device 20 or the slave station device 30 to the base station 50.

The slave station device 30 is connected to an antenna 70 for wireless communication with the terminal device 60 by a wired cable, and transmits and receives a wireless signal to and from the terminal device 60 via the antenna 70. The slave station device 30 relays a wireless signal received from the terminal device 60 to the master station device 10 or the relay device 20. The slave station device 30 relays the wireless signal received from the master station device 10 or the relay device 20 to the terminal device 60.

In the distributed antenna system 1 that has such a configuration, it is possible to connect the wireless terminal at which a radio wave does not arrive directly to the base station 50, and it is possible to expand the communicable range of the mobile communication network covered by the base station 50. For example, the distributed antenna system 1 is applicable to a mobile communication network such as 5G.

On the other hand, in mobile communication of the related art, there is a time division duplex (TDD) scheme in which uplink communication and downlink communication are executed while being switched every predetermined period of time. Therefore, when the distributed antenna system 1 is applied to a mobile communication network, the distributed antenna system 1 needs to detect this switching and appropriately switch between the DL processing and the UL processing. Therefore, in order to expand a communicable range of the mobile communication network without deteriorating the communication quality, it is necessary to accurately detect the switching between the uplink communication and the downlink communication.

In a radio signal such as 4G of the related art, it is determined by power detection whether there is a DL signal from the base station 50, and DL/UL switching is executed according to a determination result. A communication device that shares mobile operators with one DAS interferes with each other when the DL/UL switching timings of the operators are shifted, and thus detects a head symbol of a DL radio frame and detects the shift of the DL/UL switching timings between the operators.

However, in a radio signal such as 5G, there is a case where there is no power (signal) in the head symbol of the radio frame. Therefore, it is difficult for the master station device 10 to accurately detect the DL/UL switching timings by a conventional power detection method or a head symbol detection method of the related art.

In the distributed antenna system 1 including the master station device 10 connected to a base station 50 and one or more slave station devices 30 that relay signals between the terminal device 60 communicating with the base station 50 and the master station device 10, the master station device 10 is a communication device that functions as the master station device 10 or the slave station device 30 and receives an orthogonal frequency division multiplexing (OFDM) signal transmitted by a time division multiplexing scheme. The master station device 10 receives a radio frame including a synchronization signal block (SS/PBCH block (SSB)) in the distributed antenna system 1 by the TDD scheme in which the DL communication and the UL communication are switched every predetermined period of time. The SSB includes a primary synchronization signal (PSS), a secondary synchronization signal (SSS), and a physical broadcast channel (PBCH). Then, the master station device 10 detects the SSB from the received radio frame and decodes the SSB to ascertain at which position the received SSB is placed in the radio frame.

Then, the master station device 10 estimates a DL/UL switching timing based on the position of the SSB in the radio frame and a DL/UL pattern of the TDD scheme. Accordingly, the master station device 10 can estimate the DL/UL switching timing even when there is no power (signal) in the head symbol of the radio frame such as a 5G radio signal.

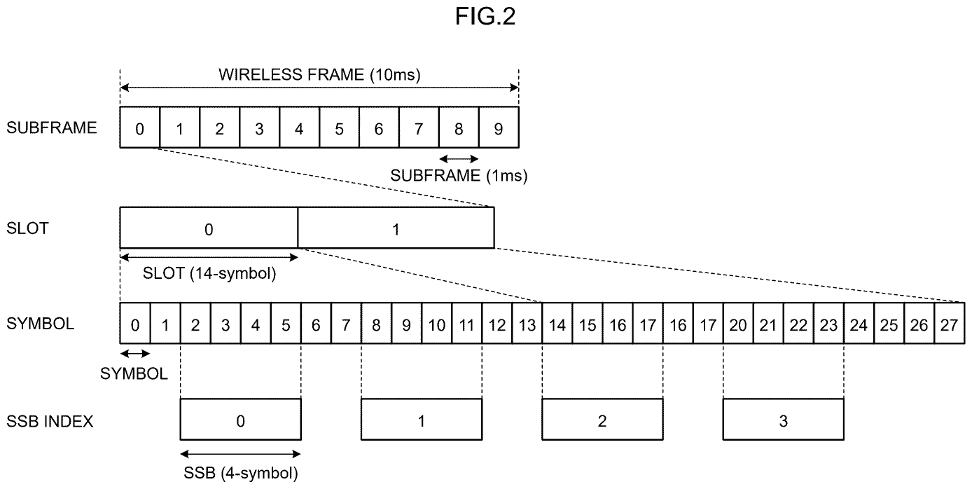

FIG. 2 is a diagram illustrating an example of a data configuration of a radio frame. FIG. 2 illustrates an example of a 5G radio frame. One frame is transmitted in 10 ms. Further, one frame includes 10 subframes transmitted in 1 ms. Here, in 5G, a plurality of subcarrier frequency intervals are supported, and the length of one symbol is also different due to this difference. Therefore, a concept of a slot is incorporated into a radio frame, the number of symbols per subframe is divided into slots, and a difference in one symbol length due to a difference in subcarrier frequency intervals is absorbed by the number of slots per subframe. One slot has 14 symbols regardless of the subcarrier frequency interval. FIG. 2 illustrates a case where the subcarrier frequency interval is 30 kHz, where one subframe has 2 slots and is composed of 28 symbols. As shown in FIG. 2, the SSB is located at a specific location in the radio frame.

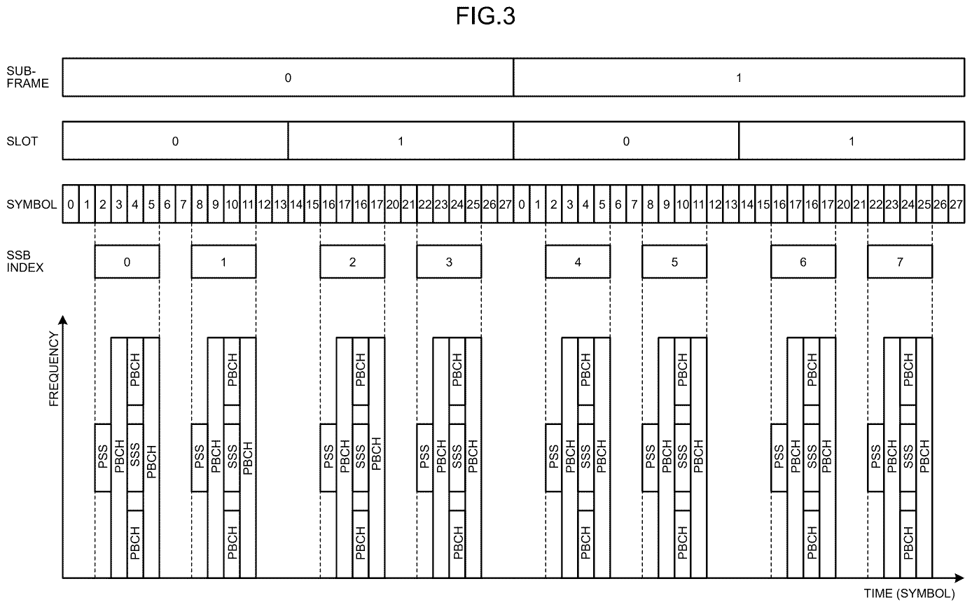

FIG. 3 is a diagram illustrating an example of an SSB displacement pattern in a radio frame. The SSB includes four symbols. The SSB includes two synchronization signals of the PSS and the SSS and a PBCH signal. The PBCH signal has a demodulation of reference signal (DMRS) for a PBCH signal which is a reference signal for decoding the PBCH signal. Each of the locations of the SSBs in the radio frame is allocated an SSB index number. For example, in an operation in Japan, values of 0 to 7 are allocated as illustrated in FIG. 3. A position at which the SSB is placed depends on an operator. Therefore, after the SSB is detected, it is necessary to identify where this SSB is positioned.

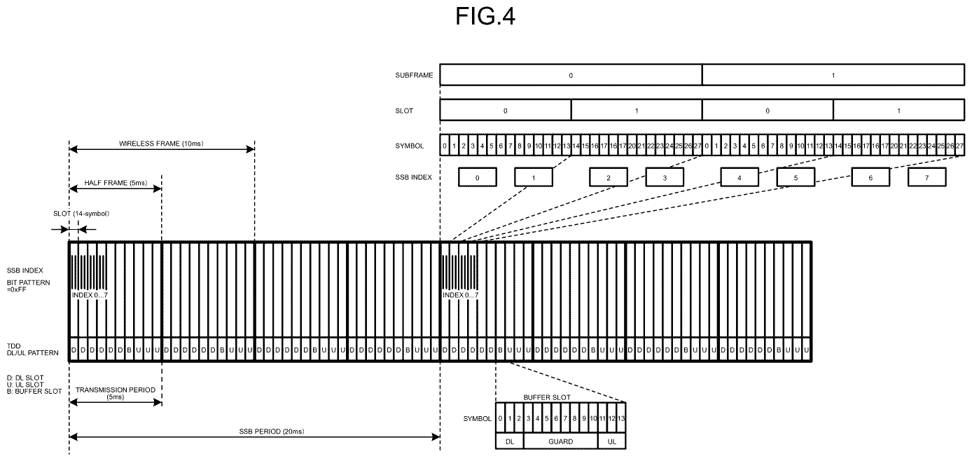

FIG. 4 is a diagram illustrating an example of a DL/UL configuration and an SSB displacement of a TDD scheme. The SSB illustrated in FIG. 4 indicates a case where a subcarrier frequency interval is 30 kHz, an SSB period is 20 ms, and a transmission period is 5 ms. In the transmission period, 10 slots are included, DL is allocated to the first 6 slots, UL is allocated to the last 3 slots, and a buffer slot is allocated between the DL slot and the UL slot. In this way, the number of consecutive DL slots and the number of consecutive UL slots within the transmission period are set in advance. The consecutive DL symbols, the consecutive UL symbols, and a blank symbol functioning as a guard therebetween are also allocated to the buffer slot. The SSB illustrated in FIG. 4 indicates a configuration in which three symbols and eight symbols serving as the guard are allocated to each of the DL symbol and the UP symbol.

From the above, if an index number of the SSB placed at a specific position of the radio frame can be detected, the master station device 10 can estimate a position where the SSB is placed in the transmission period. Further, when DL/UL configuration information of the TDD scheme is known, the master station device 10 can estimate the DL/UL switching timing within the transmission period based on a relative relationship from the displacement position of the SSB.

Hereinafter, a direction of communication from the base station 50 to the terminal device 60 is referred to as a downstream direction (downlink), and a direction opposite thereto is referred to as an upstream direction (uplink). Correspondingly, a signal transmitted in the downlink direction is referred to as a “DL signal”, and a signal transmitted in the uplink direction is referred to as a “UL signal”.

Further, a downlink signal transmitted in a frame mode is referred to as a “downlink frame”, and an uplink signal transmitted in a frame mode is referred to as an “uplink frame”. An uplink direction side of a certain device may be referred to as “upper”, and a downlink direction side may be referred to as “lower”. Correspondingly, a device connected to an upper side of a certain device may be referred to as an “upper device”, and a device connected to a lower side may be referred to as a “lower device”.

For example, the master station device 10 is an upper device of the relay device 20 and the slave station device 30, and the relay device 20 is an upper device of the slave station device 30. On the other hand, conversely, the relay device 20 and the slave station device 30 are lower devices of the master station device 10, and the slave station device 30 is a lower device of the master station device 10 and the relay device 20.

FIG. 5 is a diagram illustrating an example of a functional configuration of the master station device 10 according to the first embodiment. The master station device 10 includes a central processing unit (CPU), a memory, and an auxiliary storage device connected by a bus, and executes a program. The master station device 10 includes an upper input/output unit 11, a lower input/output unit 12, a downlink processing unit 13, an uplink processing unit 14, and a control unit 15 by executing a program. Some or all of the functions of the master station device 10 may be implemented using hardware such as an application specific integrated circuit (ASIC), a programmable logic device (PLD), or a field programmable gate array (FPGA). The program may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The program may be transmitted via a telecommunication line.

The upper input/output unit 11 is a communication interface that inputs and outputs a radio signal to and from the upper device of the master station device 10.

Specifically, the upper input/output unit 11 is a communication interface that inputs and outputs a radio signal to and from the base station 50 via a coaxial cable. The upper input/output unit 11 outputs the DL signal received from the base station 50 to the downlink processing unit 13, and outputs the UL signal input from the uplink processing unit 14 to the base station 50.

The lower input/output unit 12 is a communication interface that inputs and outputs a radio signal to and from the lower device of the master station device 10.

Specifically, the lower input/output unit 12 is a communication interface that inputs and outputs a radio signal to and from the slave station device 30. The lower input/output unit 12 outputs an UL signal received from the slave station device 30 to the uplink processing unit 14, and outputs a DL signal input from the downlink processing unit 13 to the slave station device 30.

The downlink processing unit 13 executes processing (hereinafter referred to as “DL processing”) for outputting a DL signal received by the master station device 10 from the host device to the lower device. Specifically, the DL processing of the master station device 10 includes analog to digital (AD) conversion processing on the DL signal received from the base station 50, and mapping processing of associating the digital signal with the frame. The downlink processing unit 13 outputs a downlink frame associated with the DL signal in the DL processing to the lower input/output unit 12.

The uplink processing unit 14 executes processing (hereinafter referred to as “UL processing”) for outputting the UL signal received by the master station device 10 from the lower device to the upper device. Specifically, the UL processing of the master station device 10 includes demapping processing for acquiring the UL signal from the uplink frame received from the relay device 20 or the slave station device 30, and digital to analog (DA) conversion processing on the UL signal acquired by the demapping processing. The uplink processing unit 14 outputs the UL signal converted into the analog signal in the UL processing to the upper input/output unit 11.

The control unit 15 has a function of switching between uplink communication and downlink communication in the master station device 10. Specifically, the control unit 15 has a function of detecting the switching between the uplink communication and the downlink communication, and switches between the DL processing and the UL processing (transmission operation) at a timing at which the switching between the uplink communication and the downlink communication is detected.

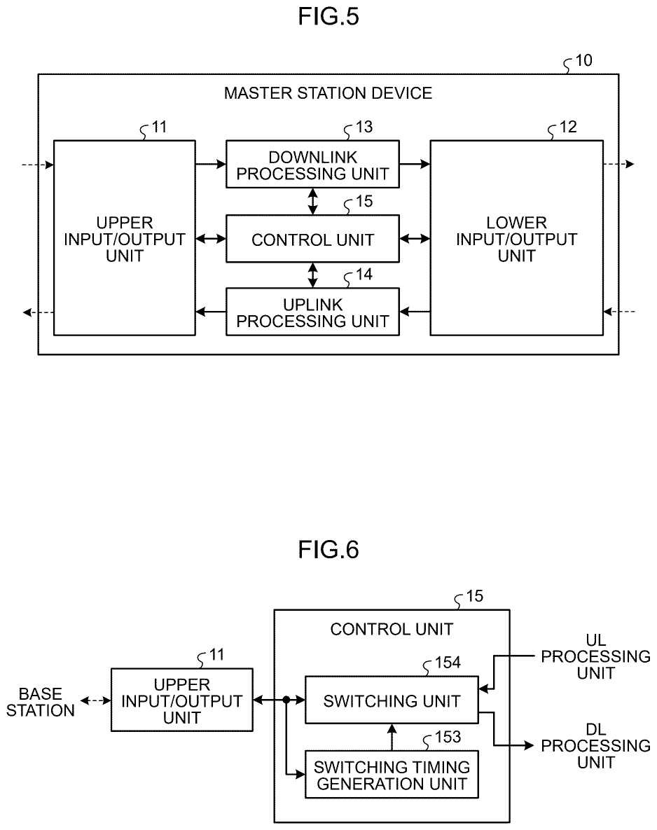

FIG. 6 is a diagram illustrating an example of a functional configuration of the control unit 15 according to the first embodiment. The control unit 15 includes a switching timing generation unit 153 and a switching unit 154.

The switching timing generation unit 153 estimates a UL period or a DL period, and provides notification of the switching timing between the UL processing and the DL processing. Specifically, the switching timing generation unit 153 provides notification of a start timing of the estimated UL period or DL period. Notification of the start timing may be provided as the start time of the UL period or the DL period, or may be provided as a time elapsed from the current time. The notification of the start timing may be a notification of arrival of the start timing.

The switching unit 154 switches between the UL processing and the DL processing at the switching timing notification that is provided by the switching timing generation unit 153.

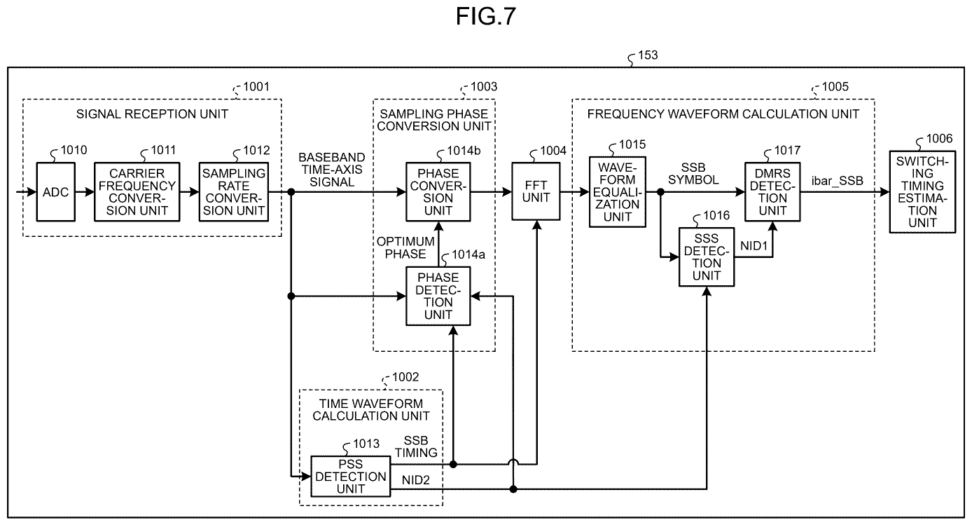

FIG. 7 is a diagram illustrating an example of a functional configuration of the switching timing generation unit 153 according to the first embodiment. The switching timing generation unit 153 includes a signal reception unit 1001, a time waveform calculation unit 1002, a sampling phase conversion unit 1003, a fast Fourier transform (FFT) unit 1004, a frequency waveform calculation unit 1005, and a switching timing estimation unit 1006.

The signal reception unit 1001 includes an ADC unit 1010, a carrier frequency conversion unit 1011, and a sampling rate conversion unit 1012. The signal reception unit 1001 receives an OFDM signal and converts the OFDM signal into a baseband time-axis waveform signal. More specifically, the signal reception unit 1001 receives a radio frame including the SSB. That is, the signal reception unit 1001 receives the SSB including the PSS, the SSS, and the PBCH including the DMRS.

The ADC unit 1010 converts an input analog signal into a digital signal and outputs the digital signal to the carrier frequency conversion unit 1011. The carrier frequency conversion unit 1011 frequency-down-converts the input digital signal, converts the digital signal into a baseband signal, and outputs the baseband signal to the sampling rate conversion unit 1012. The sampling rate conversion unit 1012 generates a baseband time-axis waveform signal that is a baseband time-axis waveform signal by converting a sampling rate of the input baseband signal. The sampling rate conversion unit 1012 outputs the baseband time-axis waveform signal to a PSS detection unit 1013, a phase detection unit 1014a, a phase conversion unit 104b, or a sampling phase conversion unit 1003.

The time waveform calculation unit 1002 includes a PSS detection unit 1013.

The time waveform calculation unit 1002 extracts a part of a baseband time-axis waveform signal that is output of the signal reception unit 1001, and calculates a degree of similarity (for example, a correlation value) between the extracted signal and a known signal.

The PSS detection unit 1013 detects the PSS signal included in the time-axis waveform signal. More specifically, the PSS detection unit 1013 detects the PSS signal placed at the head of the SSB from the baseband signal after the sampling rate conversion, and outputs the detected timing to the sampling phase conversion unit 1003 and the FFT unit 1004 as the SSB timing. The PSS detection unit 1013 determines which of PSS code sequences corresponds to the detected PSS signal, and outputs NID2 that is a cell identifier of a physical layer to the sampling phase conversion unit 1003 and an SSS detection unit 1016. A configuration of the PSS detection unit 1013 will be described below in detail.

The sampling phase conversion unit 1003 includes the phase detection unit 1014a and the phase conversion unit 1014b. The sampling phase conversion unit 1003 executes sampling phase conversion processing for converting the sampling phase of the time waveform signal that is the output of the signal reception unit 1001 based on the degree of similarity calculated by the time waveform calculation unit 1002.

The phase detection unit 1014a detects an optimum phase at which the sampling phase of the time-axis waveform signal is the best based on the SSB timing that is output of the PSS detection unit 1013 and the physical layer cell identifier NID2. That is, the phase detection unit 1014a cuts out a signal from the input baseband signal after the sampling rate conversion based on the input SSB timing, detects an optimum phase from among predetermined sampling phases based on the input physical layer cell identifier NID2, and outputs the optimum phase to the phase conversion unit 1014b. The configuration of the phase detection unit 1014a will be described below in detail.

The phase conversion unit 1014b converts the sampling phase of the time-axis waveform signal based on the optimum phase that is the output of the phase detection unit 1014a. That is, the phase conversion unit 1014b converts the sampling phase of the input baseband signal after the sampling rate conversion into the optimum phase based on the input optimum phase, and outputs the optimum phase to the FFT unit 1004. The configuration of phase conversion unit 1014b will be described below in detail.

The FFT unit 1004 executes FFT on the time-axis waveform signal that is output of the sampling phase conversion unit 1003. More specifically, the FFT unit 1004 cuts out the SSB from the baseband time-axis waveform signal after the sampling phase conversion based on the input SSB timing and executes the Fourier transform. Then, the FFT unit 1004 outputs the frequency-axis waveform signal of the SSB acquired by the Fourier transform to a waveform equalization unit 1015.

The frequency waveform calculation unit 1005 includes a waveform equalization unit 1015, an SSS detection unit 1016, and a DMRS detection unit 1017.

The frequency waveform calculation unit 1005 extracts a part of the frequency-axis waveform signal that is output of the FFT unit 1004, and calculates a degree of similarity between the extracted signal and a known signal.

The waveform equalization unit 1015 corrects at least one of amplitude and phase distortion on an IQ complex plane with respect to the frequency-axis waveform signal. More specifically, the waveform equalization unit 1015 corrects at least one of amplitude and phase distortion on the IQ complex plane for the frequency-axis waveform signal of the input SSB, and outputs the corrected SSB symbol to the SSS detection unit 1016 and the DMRS detection unit 1017.

The SSS detection unit 1016 detects an SSS signal included in the frequency-axis waveform signal. More specifically, the SSS detection unit 1016 detects the SSS signal from the frequency-axis waveform signal of the SSB whose waveform has been equalized by the waveform equalization unit 1015. The SSS detection unit 1016 determines which of SSS sequences corresponds to the detected signal. Then, the SSS detection unit 1016 outputs NID1 indicating a determined group of the cell identifiers of the physical layer to DMRS detection unit 1017. A configuration of the SSS detection unit 1016 will be described below in detail.

The DMRS detection unit 1017 detects a DMRS signal included in the frequency-axis waveform signal. More specifically, the DMRS detection unit 1017 detects the DMRS signal from the frequency-axis waveform signal of the SSB subjected to waveform equalization. The DMRS detection unit 1017 determines which of DMRS sequences corresponds to the detected DMRS signal. Then, the DMRS detection unit 1017 outputs ibar_SSB corresponding to the DMRS sequence to the switching timing estimation unit 1006. The configuration of DMRS detection unit 1017 will be described below in detail.

The switching timing estimation unit 1006 estimates a switching timing between uplink communication and the downlink communication in the own device based on a calculation result of the frequency waveform calculation unit 1005. More specifically, the switching timing estimation unit 1006 estimates at which position in the transmission period the SSB is placed from the input ibar_SSB. The switching timing estimation unit 1006 estimates a DL/UL switching timing within the transmission period from the displacement position of an estimation target SSB and the DL/UL configuration information in a known TDD scheme.

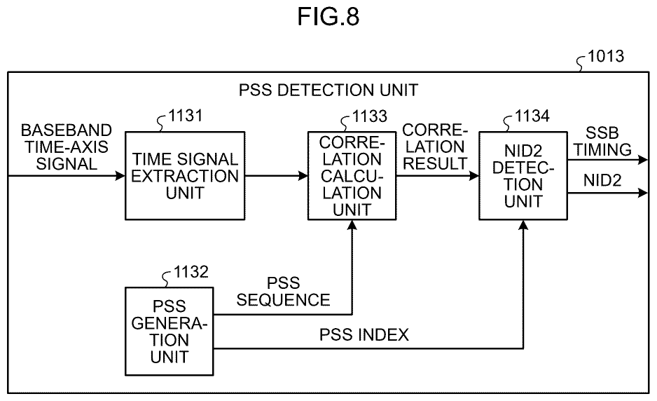

FIG. 8 is a diagram illustrating an example of a functional configuration of the PSS detection unit 1013 according to the first embodiment. The PSS detection unit 1013 includes a time signal extraction unit 1131, a PSS generation unit 1132, a correlation calculation unit 1133, and an NID2 detection unit 1134.

The time signal extraction unit 1131 extracts a part of the time-axis waveform signal. More specifically, the time signal extraction unit 1131 extracts data with the length of the OFDM symbol period from the input baseband time-axis waveform signal, and outputs the data to the correlation calculation unit 1133. That is, the time signal extraction unit 1131 outputs a part of the baseband time-axis waveform signal to the correlation calculation unit 1133.

The PSS generation unit 1132 outputs a plurality of PSS code sequences of the PSS signal and code sequence numbers for identifying the PSS code sequences. More specifically, the PSS generation unit 1132 outputs a plurality of PSS code sequences to the correlation calculation unit 1133 as PSS sequences. Further, the PSS generation unit 1132 outputs PSS indices that are code sequence numbers for identifying the PSS code sequences to the NID2 detection unit 1134.

The correlation calculation unit 1133 executes correlation calculation between the time-axis waveform signal that is output of the time signal extraction unit 1131 and the PSS sequence that is the PSS code sequence from the PSS generation unit 1132, and outputs a correlation value. The correlation calculation unit 1133 is an example of a first correlation calculation unit. That is, the correlation calculation unit 1133 executes correlation calculation between the PSS sequence and the baseband time-axis waveform signal input from the time signal extraction unit 1131, and outputs a correlation value that is a calculation result to the NID2 detection unit 1134.

The NID2 detection unit 1134 outputs, as an SSB timing, a timing at which the correlation value calculated by the correlation calculation unit 1133 is the highest in a predetermined time range, and outputs the PSS code sequence number corresponding to the PSS code sequence with the highest correlation value as NID2 that is a cell identifier of the physical layer. More specifically, the NID2 detection unit 1134 outputs, as the SSB timing, a timing at which the correlation value of the input is the highest within the predetermined time range. The NID2 detection unit 1134 outputs the PSS index corresponding to the PSS sequence with the highest correlation value as NID2 that is the cell identifier of the physical layer.

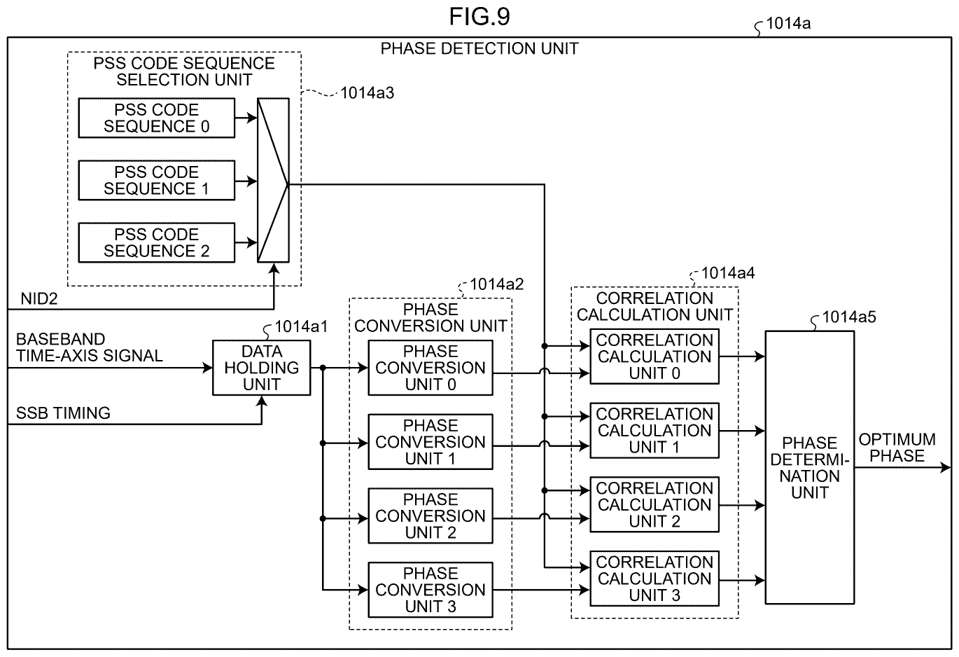

FIG. 9 is a diagram illustrating an example of a functional configuration of the phase detection unit 1014a according to the first embodiment. The phase detection unit 1014a includes a data holding unit 1014a1, a phase conversion unit 1014a2, a PSS code sequence selection unit 1014a3, a correlation calculation unit 1014a4, and a phase determination unit 1014a5.

The data holding unit 1014a1 extracts and holds a signal from the input baseband time-axis signal based on the input SSB timing, and outputs the signal to the phase conversion unit 1014a2.

The phase conversion unit 1014a2 converts the input baseband time-axis signal into predetermined sampling phases and outputs the sampling phases to the correlation calculation unit 1014a4.

The PSS code sequence selection unit 1014a3 selects one of the PSS code sequences based on the input physical layer cell identifier NID2, and outputs the selected PSS code sequence to the correlation calculation unit 1014a4.

The correlation calculation unit 1014a4 calculates a correlation value with the input PSS code sequence for each of the input phase-converted baseband time-axis signals, and outputs the correlation value to the phase determination unit 1014a5.

The phase determination unit 1014a5 determines a time-axis signal most similar to the PSS code sequence from the input correlation value, and outputs a sampling phase corresponding to the signal as an optimum phase.

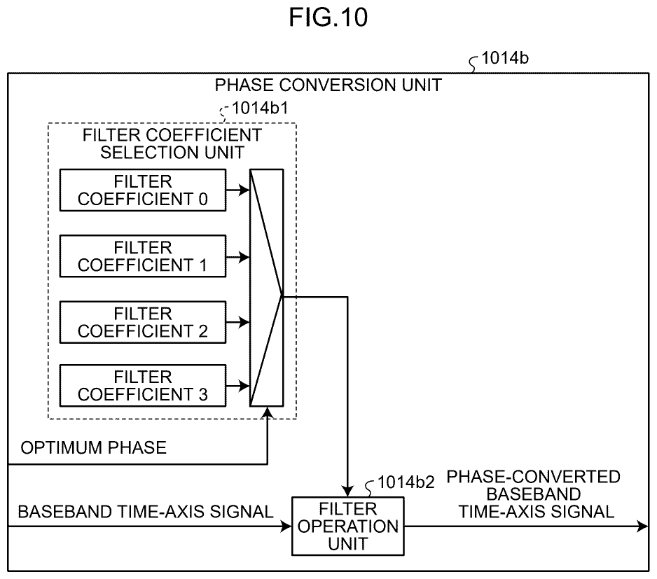

FIG. 10 is a diagram illustrating an example of a functional configuration of the phase conversion unit 1014b according to the first embodiment. The phase conversion unit 1014b includes a filter coefficient selection unit 1014b1 and a filter operation unit 1014b2.

The filter coefficient selection unit 1014b1 selects one of filter coefficients based on the input optimum phase, and outputs the selected filter coefficient to the filter operation unit 1014b2. For example, the filter coefficient selection unit 1014b1 selects a filter coefficient for matching or approaching the sampling phase close to the optimum phase from filter coefficient 0, filter coefficient 1, filter coefficient 2, and filter coefficient 3. FIG. 10 illustrate four filter coefficients of filter coefficient 0, filter coefficient 1, filter coefficient 2, and filter coefficient 3, and any number of filter coefficients serving as selection candidates can be set.

Based on the input filter coefficient, the filter operation unit 1014b2 converts the input baseband time-axis signal into a predetermined sampling phase, and outputs the sampling phase.

Based on the input filter coefficient, the filter operation unit 1014b converts the input baseband time-axis signal into a predetermined sampling phase, and outputs the sampling phase.

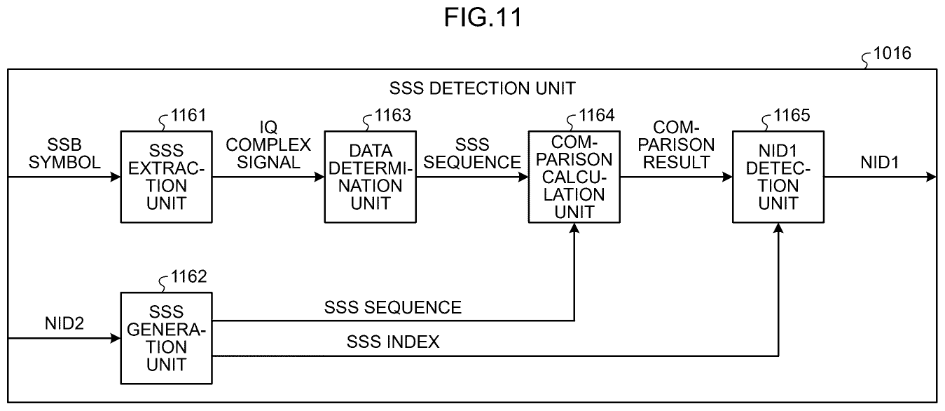

FIG. 11 is a diagram illustrating an example of a functional configuration of the SSS detection unit 1016 according to the first embodiment. The SSS detection unit 1016 includes an SSS extraction unit 1161, an SSS generation unit 1162, a data determination unit 1163, a comparison calculation unit 1164, and an NID1 detection unit 1165.

The SSS extraction unit 1161 extracts a frequency component in which the SSS signal is placed from the frequency-axis waveform signal. More specifically, the SSS extraction unit 1161 extracts a frequency component in which the SSS signal is placed from the SSB symbol that is the input frequency-axis waveform signal after the waveform equalization correction, and outputs the extracted frequency component to the data determination unit 1163. That is, the SSS extraction unit 1161 outputs the frequency component of the SSS signal.

The SSS generation unit 1162 outputs: a plurality of SSS sequences (an example of the first SSS sequences) corresponding to NID2 that is output of the PSS detection unit 1013 and is a cell identifier of a physical layer, and SSS indices for identifying the SSS sequences. More specifically, the SSS generation unit 1162 generates a plurality of SSS code sequences based on the input NID2, and outputs the SSS code sequences to the comparison calculation unit 1164 as SSS sequences. The SSS generation unit 1162 outputs the SSS indices for identifying the SSS sequences to the NID1 detection unit 1165.

The data determination unit 1163 determines demodulated data corresponding to an IQ complex coordinate position of the SSS signal that is output of the SSS extraction unit 1161, and outputs a series of data determined over the entire SSS signal to the comparison calculation unit 1164 as the SSS sequence (an example of the second SSS sequence). The data determination unit 1163 is an example of a first data determination unit.

The comparison calculation unit 1164 compares the SSS sequence from the data determination unit 1163 with the SSS sequence from the SSS generation unit 1162, and outputs the number of matches of values to the NID1 detection unit 1165 as a comparison result. The comparison calculation unit 1164 is an example of a first comparison calculation unit. The comparison calculation unit 1164 may output a degree of similarity indicating a degree of similarity between the SSS sequence from the data determination unit 1163 and the SSS sequence from the SSS generation unit 1162 to the NID1 detection unit 1165.

The NID1 detection unit 1165 determines the highest number of matches in the comparison result that is output of the comparison calculation unit 1164. Then, the NID1 detection unit 1165 outputs the SSS index corresponding to the SSS sequence with the highest number of matches as NID1 indicating the group of cell identifiers of the physical layer. The NID1 detection unit 1165 is an example of a first NID1 detection unit.

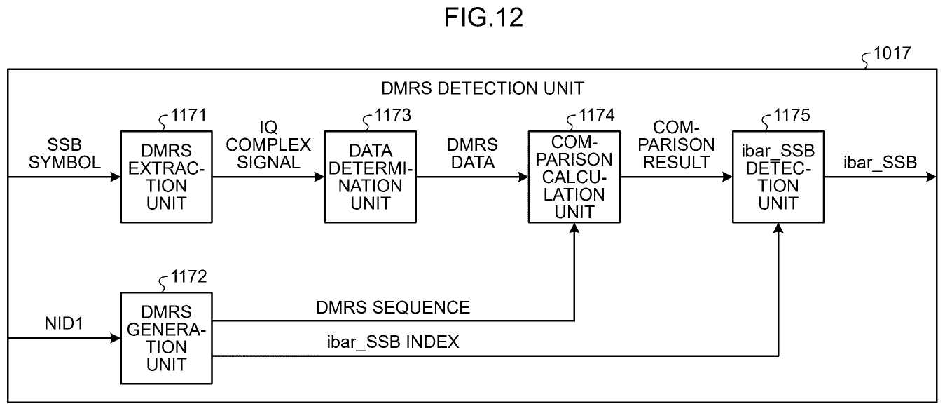

FIG. 12 is a diagram illustrating an example of a functional configuration of the DMRS detection unit 1017 according to the first embodiment. The DMRS detection unit 1017 includes a DMRS extraction unit 1171, a DMRS generation unit 1172, a data determination unit 1173, a comparison calculation unit 1174, and an ibar_SSB detection unit 1175.

The DMRS extraction unit 1171 extracts a frequency component in which the DMRS signal is displaced from the frequency-axis waveform signal. More specifically, the DMRS extraction unit 1171 extracts a frequency component in which the DMRS signal is displaced from the SSB symbol that is the input frequency-axis waveform signal after the waveform equalization correction, and outputs the extracted frequency component to the data determination unit 1173. That is, the DMRS extraction unit 1171 outputs the frequency component of the DMRS signal.

The DMRS generation unit 1172 outputs: a plurality of DMRS sequences (an example of the first DMRS sequences) corresponding to NID1 indicating a group of the cell identifiers of the physical layer that is output of the SSS detection unit 1016, and ibar_SSB indices for identifying the DMRS sequences. More specifically, the DMRS generation unit 1172 generates a plurality of code sequences based on input NID1, and outputs the code sequences as DMRS sequences to the comparison calculation unit 1174. Further, the DMRS generation unit 1172 outputs the DMRS indices for identifying the DMRS sequences to the ibar_SSB detection unit 1175.

The data determination unit 1173 determines demodulated data corresponding to an IQ complex coordinate position of the DMRS signal that is output of the DMRS extraction unit 1171, and outputs a series of data determined over the entire DMRS signal to the comparison calculation unit 1174 as a DMRS sequence (an example of the second DMRS sequence). The data determination unit 1173 is an example of a second data determination unit.

The comparison calculation unit 1174 compares the DMRS sequence from the data determination unit 1173 with the DMRS sequence from the DMRS generation unit 1172, and outputs, as a comparison result, the number of matches of values to the ibar_SSB detection unit 1175. The comparison calculation unit 1174 is an example of a third comparison calculation unit.

The ibar_SSB detection unit 1175 determines the highest number of matches from the comparison result that is output of the comparison calculation unit 1174.

Then, the ibar_SSB detection unit 1175 outputs, as ibar_SSB, the ibar_SSB index corresponding to the DMRS sequence with the highest number of matches. The ibar_SSB detection unit 1175 is an example of a first ibar_SSB detection unit.

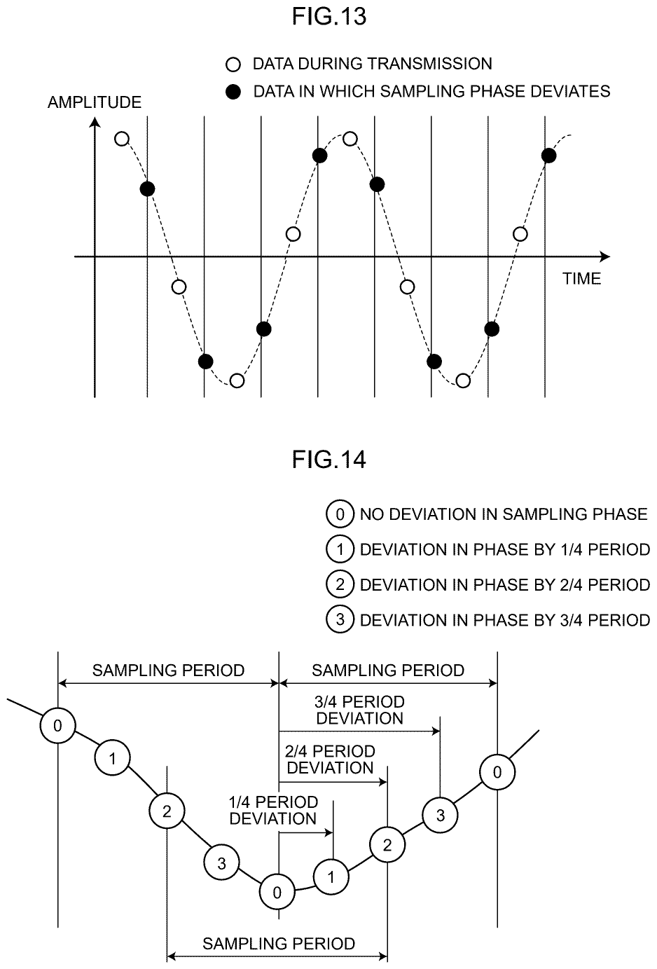

Next, a phenomenon in which a sampling phase of a baseband time-axis waveform signal deviates from a sampling phase during transmission by the AD conversion and the down-sampling rate conversion in the communication device will be described with reference to FIGS. 13 to 18.

FIG. 13 is a diagram illustrating data deviating from the sampling phase during transmission using a single sine wave as an example. A white circle indicates data during transmission, and a black circle indicates data in which a sampling phase deviates by down-sampling rate conversion after AD conversion. An interval of the white circle and an interval of the black circle are both equal and indicate that a sampling period is the same. The deviation in the sampling phase affects the frequency-axis waveform signal that is output of the FFT processing.

FIG. 14 is a diagram illustrating data in which the sampling phase deviates in units of ¼ of the sampling period. Hereinafter, for example, a mark indicating that “0” is written in ◯ is expressed as “◯0” . ◯0 indicates a case where there is no deviation of the sampling phase. In ◯1, ◯2, and ◯3, the sampling phase deviates from ◯0 by amounts corresponding to ¼, 2/4, and ¾ of the sampling period, respectively. The sampling period is the same in any of ◯0 to ◯3.

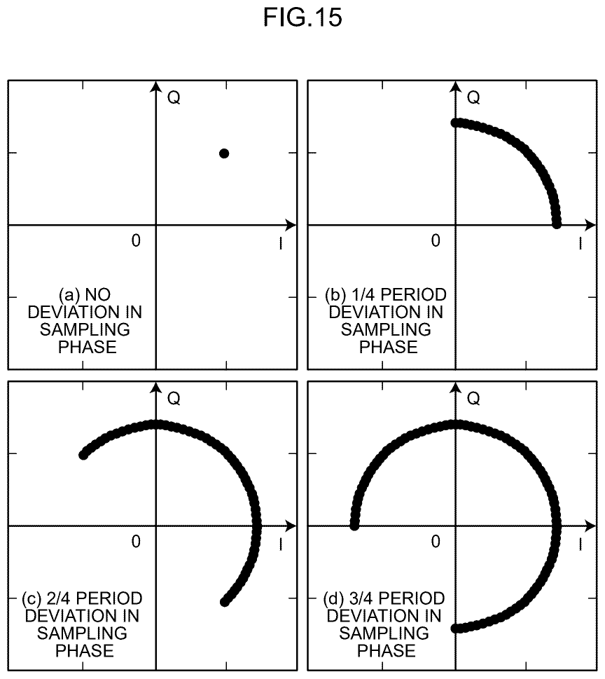

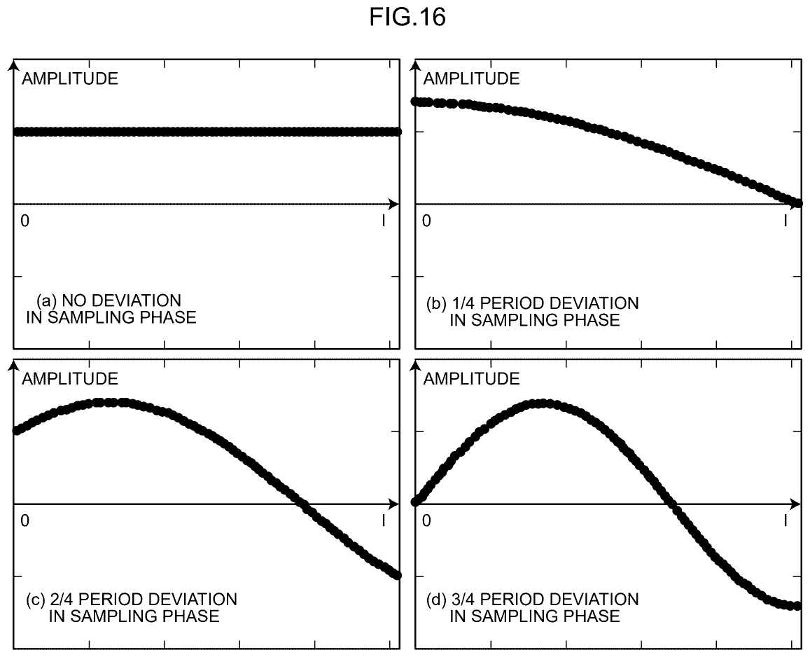

FIG. 15 illustrates an example of constellation of the frequency-axis signal obtained by executing FFT on the time-axis waveform signal using unmodulated data as an example. FIG. 16 illustrates an example of an I-axis waveform of the frequency-axis signal obtained by executing FFT on the time-axis waveform signal using unmodulated data as an example.

In FIG. 15 or 16, since unmodulated data is used, the constellation converges to one point and an I-axis waveform becomes a straight line in a case (a) in which there is no deviation in the sampling phase. Here, as a data determination method, when code determination is introduced in such a manner that “0” is determined in a case where a signal is a positive value and “1” is determined in a case where the signal is a negative value, data “00” is demodulated in a case where there is the signal in the first quadrant of an IQ complex plane. Accordingly, in the case (a) in which all the signals converge to one point in the first quadrant, all the signals become “00”, which is appropriate as demodulation of the unmodulated data, when the signals are demodulated.

Next, in a case (b) of deviation by ¼ of the sampling period, the constellation rotates by 90°, and an I-axis waveform becomes a waveform obtained by cutting out a ¼ period from 0° to 90° of a cos wave (cosine wave). When the above code determination is executed, most of the demodulation results become “00”. However, the signals at both ends are close to a code boundary, and “10” or “01” is determined due to a slight influence of thermal noise or the like, and a demodulation result may be erroneous.

Moreover, in a case (c) of deviation by 2/4 of the sampling period, the constellation rotates by 180°, and the I-axis waveform becomes a waveform obtained by cutting out a 2/4 period from −45° to 135° of the cos wave (cosine wave). When the sign determination is executed, half of the signals are correctly determined as “00”. However, ¼ of the signals are erroneously determined as “10” and “01”.

Finally, in a case (d) deviation by ¾ of the sampling period, the constellation rotates by 270°, and the I-axis waveform becomes a waveform obtained by cutting out a ¾ period from −90° to 180° of the cos wave (cosine wave). When the sign determination is executed, ⅓ of the signals are correctly determined as “00”, but ⅓ of the signals are erroneously determined as “10” and “01”.

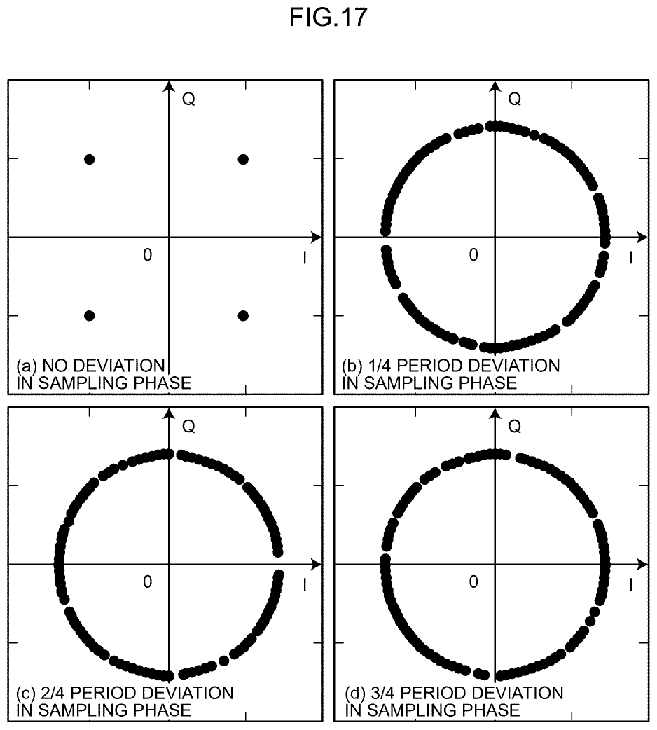

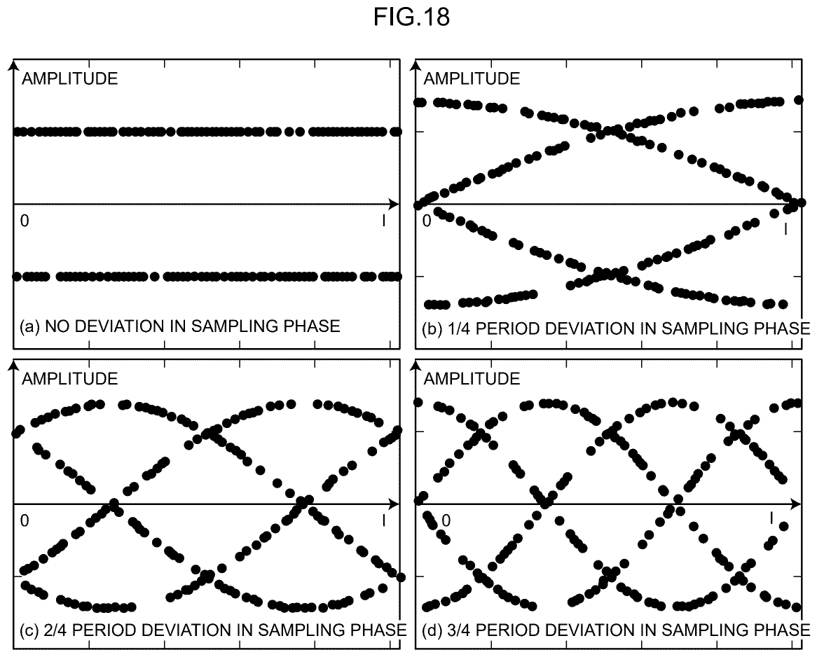

Next, an example of modulated data rather than unmodulated data will be described. FIG. 17 illustrates an example of a constellation of the frequency-axis signal obtained by executing FFT on the time-axis waveform signal using data subjected to quadrature phase shift keying (QPSK) as an example. FIG. 18 illustrates an example of an I-axis waveform of the frequency-axis signal obtained by executing FFT on the time-axis waveform signal using data also subjected to quadrature phase shift keying (QPSK) as an example.

In the case (a) in which there is no deviation in the sampling phase, the data converges in each of the four quadrants in the constellation, and the I-axis waveform becomes a straight line corresponding to each convergence point. On the other hand, in the cases (b), (c), and (d), the constellation is a unit circle, and the outer appearance cannot be distinguished. The I-axis waveform looks appears as if four waveforms obtained by cutting out a ¼ period of the cos wave in (b) overlap, and each of the four waveforms corresponds to a signal present in four quadrants. Similarly, four waveforms obtained by cutting out a 2/4 period in (c) and cutting out a ¾ period in (d) appear to overlap. When the above code determination is executed, a ratio of signals erroneously determined is the same as that in the case of no modulation, and ½ is erroneous in (c), and ⅔ is erroneous in (d).

As described above, when data is determined to be in a state in which there is phase rotation on an IQ complex plane with respect to data subjected to phase shift keying (PSK), reception characteristics greatly deteriorate. Therefore, data determination is generally executed after the phase rotation is corrected.

In order to correct the phase rotation, a mechanism for controlling a phase of a clock for AD conversion or a baseband system clock, and a waveform equalization process of correcting a waveform after FFT are necessary. However, such a process is complicated and it is costly to implement the device.

Therefore, the communication device according to the present embodiment estimates a DL/DL switching timing at low cost and with high accuracy by sampling phase conversion processing even when the sampling phase deviates from an original phase in the TDD scheme.

Next, various processes such as TDD detection processing executed by the master station device 10 according to the first embodiment and sampling phase conversion processing executed in the TDD detection process will be described.

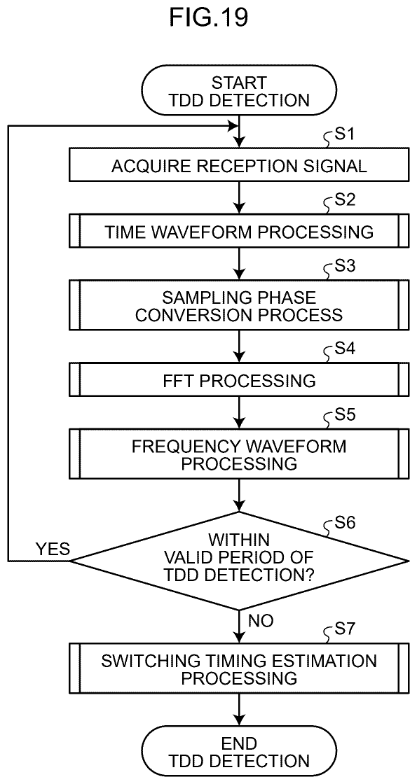

FIG. 19 is a flowchart illustrating an example of TDD detection processing according to the first embodiment.

Here, it is assumed that the distributed antenna system 1 is receiving an analog radio signal of either the DL signal or the UL signal. In addition, it is assumed that the distributed antenna system 1 can refer to identification information indicating validity or invalidity of a TDD detection processing period and DL/UL configuration information of TDD.

The signal reception unit 1001 executes AD conversion, frequency down-conversion, and sampling rate conversion on an input analog signal, and acquires a baseband time-axis waveform signal as a reception signal (Step S1).

Subsequently, the time waveform calculation unit 1002 executes time waveform processing (Step S2). That is, the time waveform calculation unit 1002 detects the PSS signal placed at the head of the SSB from the baseband signal, and notifies the phase detection unit 1014a and the FFT unit 1004 of a detected timing as the SSB timing. It is determined which of PSS code sequences corresponds to the detected PSS signal, and the PSS signal is output to the phase detection unit 1014a and the SSS detection unit 1016 as NID2 that is a cell identifier of the physical layer.

Subsequently, the sampling phase conversion unit 1003 converts the sampling phase of the time waveform signal that is output of the signal reception unit 1001 based on the degree of similarity calculated by the time waveform calculation unit 1002 (Step S3).

Subsequently, the FFT unit 1004 cuts out the SSB from the baseband signal based on the SSB timing notification provided, executes Fourier transform, and notifies the frequency waveform calculation unit 1005 of completion of the FFT processing (Step S4).

Subsequently, the frequency waveform calculation unit 1005 detects an index number of the SSB indicating a position where the SSB is placed in the transmission period (Step S5).

The signal reception unit 1001, the time waveform calculation unit 1002, the fast Fourier transform (FFT) unit 1004, and the frequency waveform calculation unit 1005 repeatedly execute the above Steps S1 to S4 when the TDD detection process is within the valid period (Yes in Step S6).

When the TDD detection processing period ends (No in Step S6), the switching timing estimation unit 1006 estimates a position where the SSB is placed in the transmission period, and estimates the DL/UL switching timing within the transmission period from the placement position of the SSB and the DL/UL configuration information of a known TDD (Step S7).

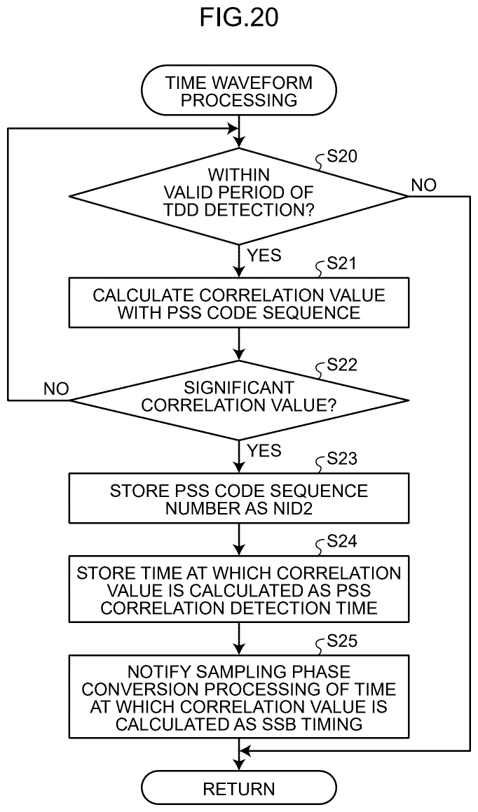

FIG. 20 is a flowchart illustrating an example of time waveform processing according to the first embodiment. That is, the flowchart illustrated in FIG. 20 is the time waveform processing of Step S2 illustrated in FIG. 19.

The time signal extraction unit 1131 determines whether the TDD detection processing period is valid (Step S20). When the TDD detection processing period is invalid (No in Step S20), the time signal extraction unit 1131 ends the time waveform processing. Conversely, when the TDD detection processing period is valid (Yes in Step S20), the time waveform calculation unit 1002 executes subsequent processing.

Subsequently, the correlation calculation unit 1133 calculates a correlation value by executing correlation calculation between the baseband time-axis waveform signal and the plurality of PSS code sequences (Step S21).

Subsequently, the NID2 detection unit 1134 determines whether there is a significant correlation value in the correlation operations (Step S22). Here, the correlation value to be significant may exceed a predetermined threshold, or may be a maximum value after the start of the time waveform processing. When there is no significant correlation value (No in Step S22), the NID2 detection unit 1134 returns to Step S11. Conversely, when there is the significant correlation value (Yes in Step S22), the NID2 detection unit 1134 executes subsequent processing.

The NID2 detection unit 1134 stores the PSS sequence that is the PSS code sequence number corresponding to the significant correlation value as NID2 (Step S23).

The NID2 detection unit 1134 stores a system time at which the significant correlation value is calculated as the PSS correlation detection time (Step S24).

The NID2 detection unit 1134 notifies the sampling phase conversion processing illustrated in Step S3 of the system time at which the significant correlation value is calculated as the SSB timing (Step S25).

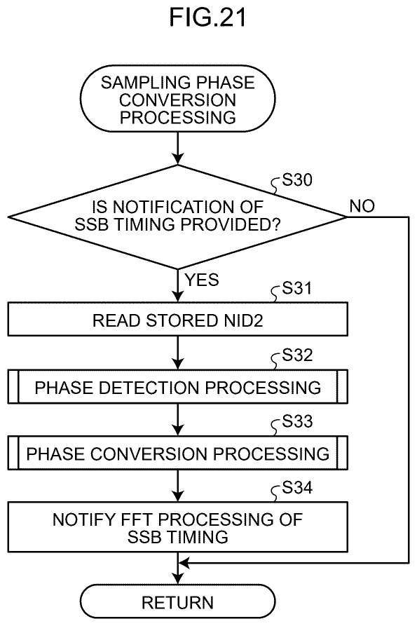

FIG. 21 is a flowchart illustrating an example of sampling phase conversion processing according to the first embodiment. That is, the flowchart illustrated in FIG. 21 is the sampling phase conversion processing of Step S3 illustrated in FIG. 19.

It is determined whether the PSS detection unit 1013 notifies the phase detection unit 1014a and the FFT unit 1004 of the SSB timing (Step S30). When there is no notification, the processing is excluded from the sampling phase conversion processing (No in Step S30). Conversely, when there is the notification, the processing proceeds to subsequent Step S31 (Yes in Step S30).

Subsequently, the phase detection unit 1014a reads the NID2 stored in Step S23 (Step S31).

Subsequently, the phase detection unit 1014a executes phase detection processing (Step S32).

Subsequently, the phase conversion unit 1014b executes phase conversion processing (Step S33).

Subsequently, the PSS detection unit 1013 notifies the FFT unit 1004 of the SSB timing (Step S34).

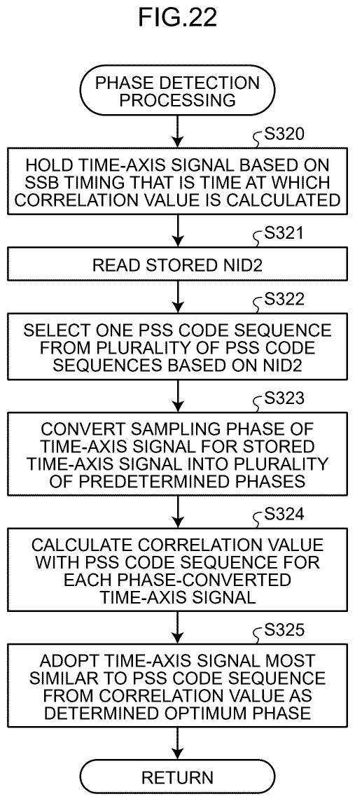

FIG. 22 is a flowchart illustrating an example of phase detection processing according to the first embodiment. That is, the flowchart illustrated in FIG. 22 is the phase detection processing of Step S32 illustrated in FIG. 21.

The data holding unit 1014al of the phase detection unit 1014a holds a time-axis signal based on the SSB timing (Step S320).

Subsequently, the phase conversion unit 1014a2 of the phase detection unit 1014a reads the NID2 stored in Step S23 (Step S321).

Subsequently, the PSS code sequence selection unit 1014a3 of the phase detection unit 1014 a selects one PSS code sequence from PSS code sequence 0, PSS code sequence 1, and PSS code sequence 2 based on NID2 (S322).

Subsequently, the phase conversion unit 1014a2 of the phase detection unit 1014a converts the sampling phase of the time-axis signal held in the data holding unit 1014a1 into a plurality of predetermined phases (Step S323).

Subsequently, the correlation calculation unit 1014a4 of the phase detection unit 1014a calculates a correlation value with the PSS code sequence selected by the PSS code sequence selection unit 1014a3 for each signal phase-converted by the phase conversion units 0 to 3 (Step S324).

Subsequently, the phase determination unit 1014a5 of the phase detection unit 1014a determines a time-axis signal similar to the PSS code sequence from the correlation value and adopts the time-axis signal as the optimum phase (Step S325).

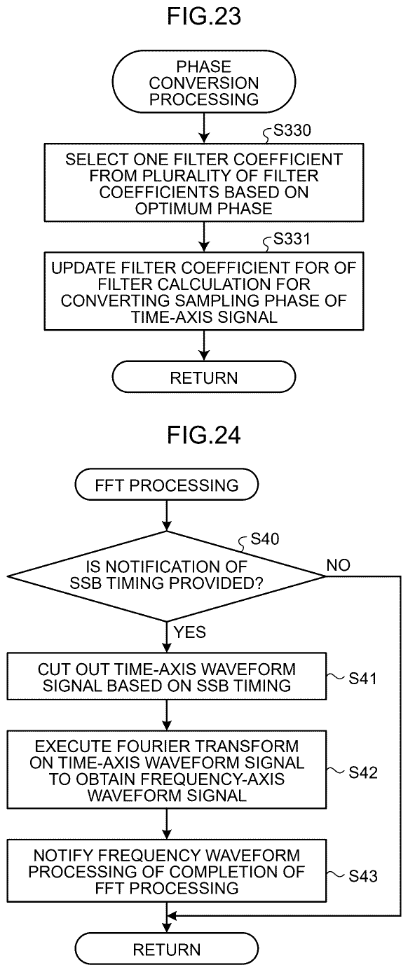

FIG. 23 is a flowchart illustrating an example of phase conversion processing according to the first embodiment. That is, the flowchart illustrated in FIG. 23 is the phase conversion processing of Step S33 illustrated in FIG. 21.

Subsequently, the filter coefficient selection unit 1014b1 of the phase conversion unit 1014 b selects one filter coefficient from filter coefficient 0, filter coefficient 1, filter coefficient 2, and filter coefficient 3 for approaching or matching the sampling phase close to the optimum phase based on the optimum phase determined by the phase determination unit 1014a5 of the phase detection unit 1014a (Step S330).

Subsequently, the filter operation unit 1014b2 of the phase conversion unit 1014b updates the filter coefficient for converting the sampling phase of the time-axis signal with the filter coefficient selected by the filter coefficient selection unit 1014b1 (Step S331).

FIG. 24 is a flowchart illustrating an example of FFT processing according to the first embodiment. That is, the flowchart illustrated in FIG. 24 is the FFT processing in Step S4.

The FFT unit 1004 determines whether notification of the SSB timing has been provided (Step S40). When there is no notification (No in Step S40), the FFT unit 1004 ends the FFT processing. Conversely, when there is the notification (Yes in Step S40), the FFT unit 1004 executes subsequent processing.

The FFT unit 1004 cuts out the SSB from the baseband signal after the sampled phase conversion based on the SSB timing notification provided (Step S41).

The FFT unit 1004 executes Fourier transform on the time-axis waveform signal of the cut-out SSB to obtain the frequency-axis waveform signal (Step S42).

The FFT unit 1004 notifies the frequency waveform processing of completion of the FFT processing illustrated in Step S4 (Step S43).

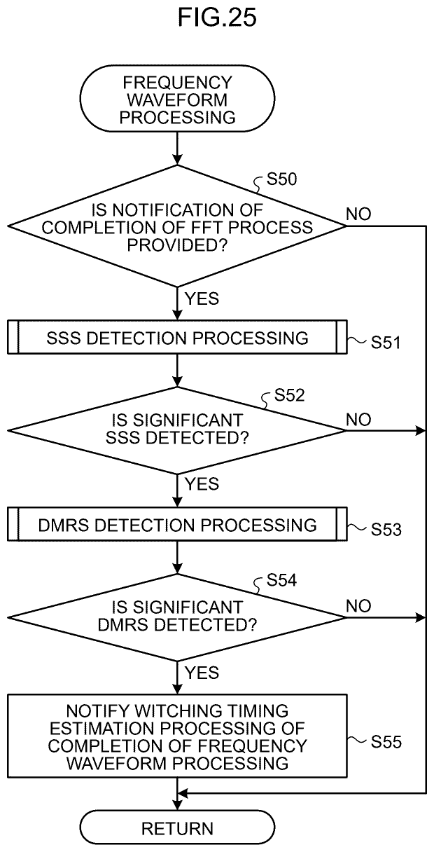

FIG. 25 is a flowchart illustrating an example of frequency waveform processing according to the first embodiment. That is, the flowchart illustrated in FIG. 25 is the frequency waveform processing of Step S5 illustrated in FIG. 19.

The frequency waveform calculation unit 1005 determines whether notification of the completion of the FFT process is provided (Step S50). When there is no notification (No in Step S50), the frequency waveform calculation unit 1005 ends the frequency waveform processing. Conversely, when there is the notification, (Yes in Step S50), the frequency waveform calculation unit 1005 executes subsequent processing.

Subsequently, the SSS detection unit 1016 executes SSS detection processing (Step S51).

Subsequently, the frequency waveform calculation unit 1005 determines whether the significant SSS is detected (Step S52). Here, the determination of the significant SSS refers to, for example, a case where the degree of similarity to the SSS sequence calculated in the SSS detection processing exceeds a predetermined threshold and is maximum. If there is no significant SSS (No in Step S52), the frequency waveform calculation unit 1005 ends the frequency waveform processing. Conversely, when there is the significant SSS (Yes in Step S52), the frequency waveform calculation unit 1005 executes subsequent processing.

Subsequently, the DMRS detection unit 1017 executes DMRS detection processing (Step S53).

Subsequently, the frequency waveform calculation unit 1005 determines whether the significant DMRS is detected (Step S54). Here, the determination of the significant SSS refers to, for example, a case where the degree of similarity to the DMRS sequence calculated in the DMRS detection process exceeds a predetermined threshold and is maximum. When there is no significant DMRS (No in Step S54), the frequency waveform calculation unit 1005 ends the frequency waveform processing. Conversely, when there is the significant DMRS (Yes in Step S54), the frequency waveform calculation unit 1005 executes subsequent processing.

Subsequently, the frequency waveform calculation unit 1005 notifies the switching timing estimation processing illustrated in Step S6 of the completion of the frequency waveform processing (Step S55).

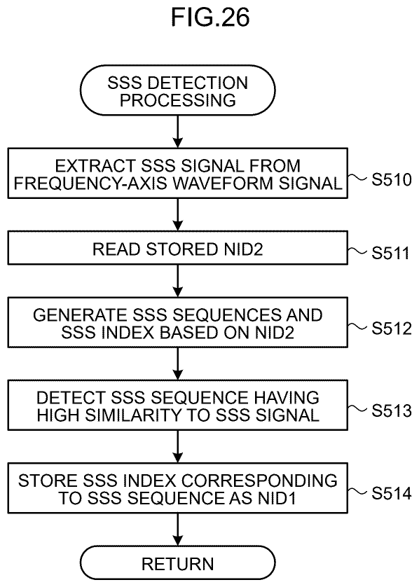

FIG. 26 is a flowchart illustrating an example of SSS detection processing according to the first embodiment. That is, the flowchart illustrated in FIG. 26 is the SSS detection processing in Step S51 illustrated in FIG. 25.

The SSS extraction unit 1161 extracts a frequency component in which the SSS signal is placed from the frequency-axis waveform signal (Step S510).

Subsequently, the SSS generation unit 1162 reads NID2 stored in Step S14 (Step S511).

Subsequently, the SSS generation unit 1162 generates a plurality of SSS sequences and SSS indices for identifying the SSS sequences based on NID2 (Step S512).

Subsequently, the comparison calculation unit 1164 detects an SSS sequence with the highest degree of similarity to the extracted SSS signal (Step S513).

Subsequently, the NID1 detection unit 1165 stores the SSS index corresponding to the SSS sequence with the highest degree of similarity as NID1 (Step S514).

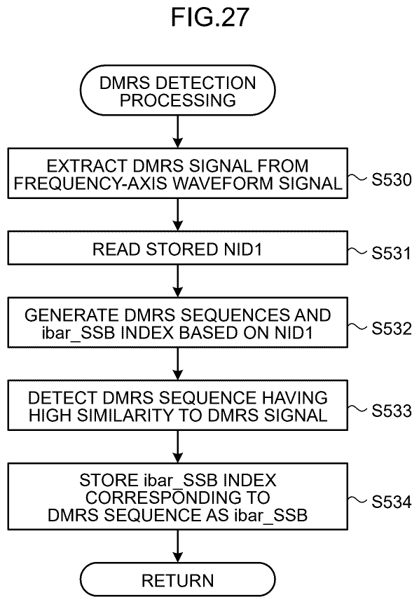

FIG. 27 is a flowchart illustrating an example of DMRS detection processing according to the first embodiment; That is, the flowchart illustrated in FIG. 27 is the DMRS detection processing in Step S53 illustrated in FIG. 25.

The DMRS extraction unit 1171 extracts a frequency component in which the DMRS signal is placed from the frequency-axis waveform signal (Step S530).

Subsequently, the DMRS generation unit 1172 reads NID1 stored in Step S514 (Step S531).

Subsequently, the DMRS generation unit 1172 generates a plurality of DMRS sequences and ibar_SSB indices for identifying the DMRS sequences based on NID1 (Step S532).

Subsequently, the comparison calculation unit 1174 detects a DMRS sequence with the highest degree of similarity to the extracted DMRS signal (Step S533).

Subsequently, the ibar_SSB detection unit 1175 stores the ibar_SSB index corresponding to the DMRS sequence with the highest degree of similarity as ibar_SSB (Step S534).

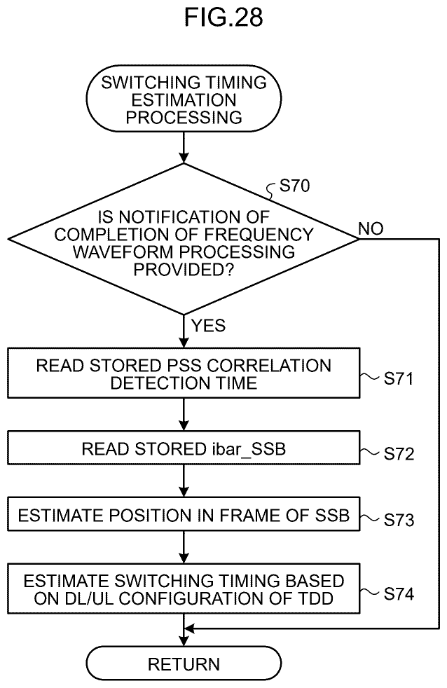

FIG. 28 is a flowchart illustrating an example of switching timing estimation processing according to the first embodiment. That is, the flowchart illustrated in FIG. 28 is the switching timing estimation processing in Step S7 illustrated in FIG. 19.

The switching timing estimation unit 1006 determines whether notification of the completion of the frequency waveform processing is provided (Step S70). When there is no notification (No in Step S70), the switching timing estimation unit 1006 ends the switching timing estimation processing. Conversely, when there is a notification (Yes in Step S70), the switching timing estimation unit 1006 executes subsequent processing.

Subsequently, the switching timing estimation unit 1006 reads the PSS correlation detection time stored in Step S24 (Step S71).

Subsequently, the switching timing estimation unit 1006 reads ibar_SSB stored in Step S534 (Step S72).

Subsequently, the switching timing estimation unit 1006 estimates a position of a frame in which the currently detected SSB is placed from a known SSB placement pattern and ibar_SSB read in Step S72 (Step S73).

Subsequently, the switching timing estimation unit 1006 estimates a timing at which TDD switching subsequently occurs from a known DL/UL configuration information of the TDD, the PSS correlation detection time read in Step S71, and the position of the frame of the SSB estimated in Step S73 (Step S74).

As described above, the switching timing generation unit 153 according to the first embodiment receives the OFDM signal and converts the OFDM signal into a baseband time-axis waveform signal. The switching timing generation unit 153 extracts a part of the time-axis waveform signal and calculates a degree of similarity (for example, a correlation value) between the extracted signal and a known signal. The switching timing generation unit 153 converts the sampling phase of the time waveform signal based on the calculated a degree of similarity. The switching timing generation unit 153 generates a frequency-axis waveform signal by executing FFT on the time-axis waveform signal. The switching timing generation unit 153 extracts a part of the frequency-axis waveform signal and calculates the degree of similarity between the part of the frequency-axis waveform signal and a known signal. The switching timing generation unit 153 estimates the switching timing between the uplink communication and the downlink communication in the own device based on the degree of similarity between the part of the frequency-axis waveform signal and a known signal.

That is, the switching timing generation unit 153 executes sampling phase conversion processing for calculating a degree of similarity between the PSS code sequence extracted from the time-axis waveform signal and a known signal, determining the optimum phase based on the calculated a degree of similarity, and converting the sampling phase of the time waveform signal to match or approach the optimum phase. Accordingly, in the TDD scheme in which the DL communication and the UL communication are switched every predetermined period of time, the switching timing generation unit 153 can accurately estimate the switching timing between the DL communication and the UL communication at low cost even when the sampling phase deviates from the original phase.

### Modification 1

Next, a case where a common phase error (CPE) is added in common to all the subcarriers will be considered. The CPE is an error in which a low-frequency component of a phase error caused by a phase fluctuation of a sine wave generated in a local oscillator is dominant. Then, in a wireless communication scheme using OFDM transmission, the CPE is generally corrected by waveform equalization processing in which a variation amount of amplitude or phase in a propagation path is estimated using a pilot signal inserted into an OFDM symbol.

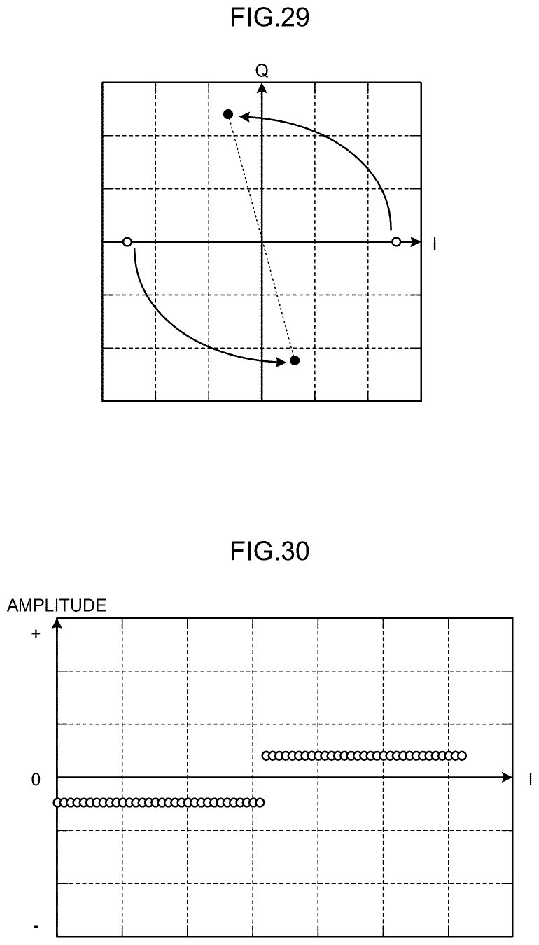

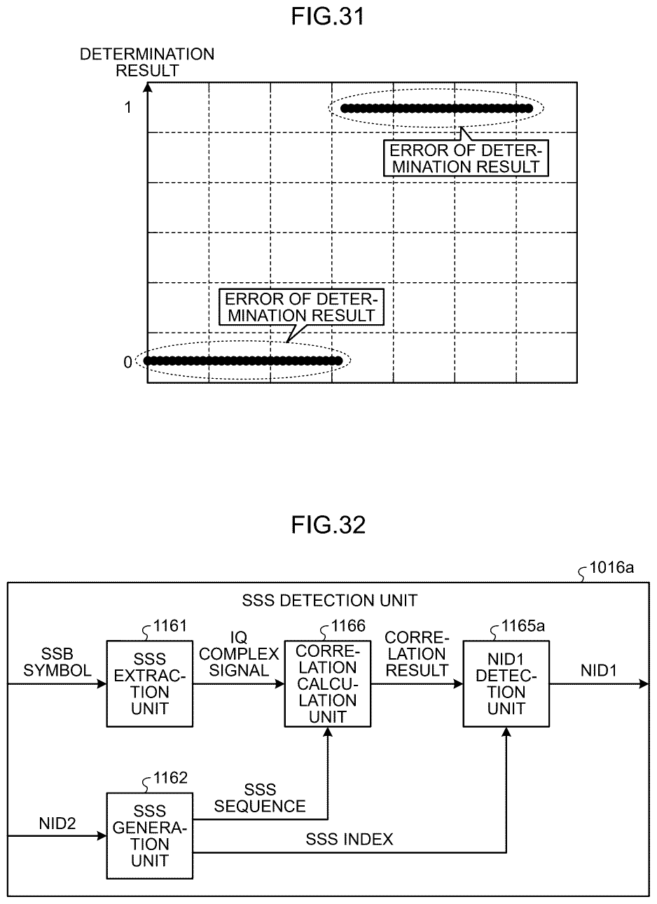

FIG. 29 is a diagram illustrating an example of a constellation when there is a CPE. FIG. 30 is a diagram illustrating an example of an I-axis signal when there is a CPE. FIG. 31 is a diagram illustrating an example of a data determination result when there is a CPE.

The transmission signal is the same as in the case where there is no phase rotation described above. However, a signal in which the CPE remains is input to the data determination unit 1163 of the SSS detection unit 1016 illustrated in FIG. 11 according to performance of the synchronization processing and waveform equalization processing. When a data determination method is the same as the above-described method of determining “1” in a case where the I-axis signal has a positive value and determining “0” in a case where the I-axis signal has a negative value, a determination result is as illustrated in FIG. 31. Since the positive and negative signs of the I-axis signal are all inverted with respect to the transmission signal, the data determination is all erroneously executed. As a result, the number of matches between the SSS sequence from the data determination unit 1163 and the SSS sequence from the SSS generation unit 1162 is low, and detection accuracy in the NID1 detection unit 1165 is low.

Accordingly, as Modification 1, an SSS detection unit and a DMRS detection unit to which CPE countermeasures are applied will be described with reference to the drawings.

FIG. 32 is a diagram illustrating an example of a functional configuration of the SSS detection unit 1016a according to Modification 1. Here, constituents having the same functions as those in FIG. 11 will be denoted by the same reference numerals, the description thereof will be omitted, and only constituents having different functions will be described.

A correlation calculation unit 1166 executes correlation calculation between the IQ complex signal of the SSS signal that is output of the SSS extraction unit 1161 and the SSS sequence from the SSS generation unit 1162. The correlation calculation unit 1166 is an example of a second correlation calculation unit. More specifically, the correlation calculation unit 1166 receives an SSS signal from the SSS extraction unit 1161 and an SSS sequence from the SSS generation unit 1162. The correlation calculation unit 1166 executes correlation calculation between the IQ complex signal of the SSS signal and the SSS sequence. Then, the correlation calculation unit 1166 outputs a correlation value that is a result of the correlation calculation, to an NID1 detection unit 1165a.

The NID1 detection unit 1165a determines a correlation result indicating the highest correlation value in the correlation result output from the correlation calculation unit 1166, and outputs an SSS index corresponding to an SSS sequence with the highest correlation value as NID1 indicating a group of cell identifiers of a physical layer. The NID1 detection unit 1165a is an example of a second NID1 detection unit. More specifically, the NID1 detection unit 1165a determines a correlation result indicating the highest correlation value in the correlation result output from the correlation calculation unit 1166. Then, the NID1 detection unit 1165a outputs the SSS index corresponding to the SSS sequence with the highest correlation value NID1 indicating a group of the cell identifiers of the physical layer.

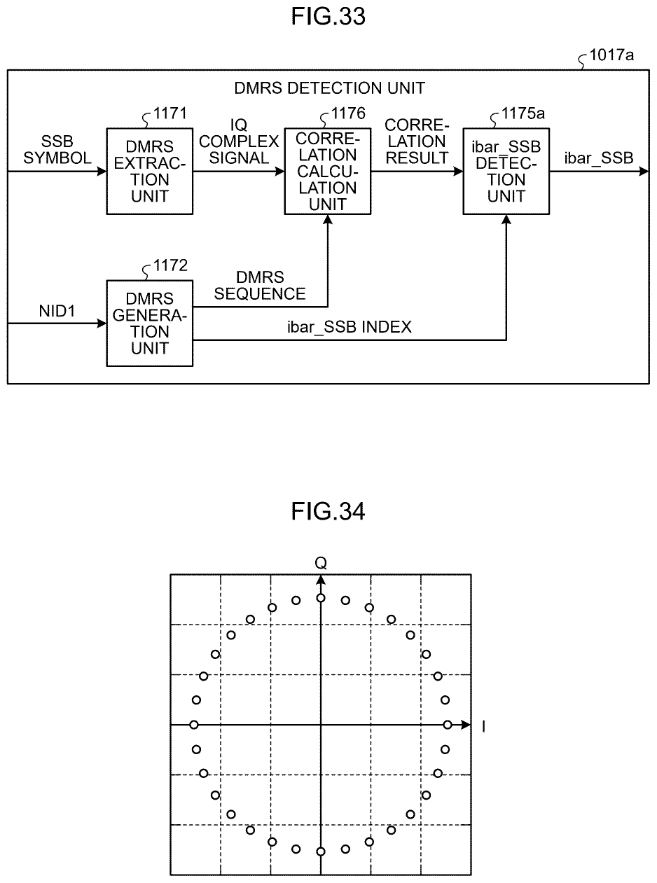

FIG. 33 is a diagram illustrating an example of a functional configuration of a DMRS detection unit 1017a according to Modification 1. Here, constituents having the same functions as those in FIG. 12 will be denoted by the same reference numerals, the description thereof will be omitted, and only constituents having different functions will be described.

A correlation calculation unit 1176 executes correlation calculation between the IQ complex signal of the DMRS signal output from the DMRS extraction unit 1171 and the DMRS sequence from the DMRS generation unit 1172. The correlation calculation unit 1176 is an example of a third correlation calculation unit. More specifically, the correlation calculation unit 1176 receives a DMRS signal from the DMRS extraction unit 1171 and a DMRS sequence from the DMRS generation unit 1172. The correlation calculation unit 1176 executes correlation calculation between the DMRS signal and the DMRS sequence. Then, the correlation calculation unit 1176 outputs a correlation value that is a result of the correlation calculation to an ibar_SSB detection unit 1175a.

The ibar_SSB detection unit 1175a determines a correlation result indicating the highest correlation value in the correlation result output from the correlation calculation unit 1176. Then, the ibar_SSB detection unit 1175a outputs an ibar_SSB index corresponding to the DMRS sequence with the highest correlation value as ibar_SSB. The ibar_SSB detection unit 1175a is an example of a second ibar_SSB detection unit.

As described above, when there is the CPE, the degree of similarity between the IQ complex signal and a known data can be accurately calculated even when there is the CPE by using the correlation calculation by the correlation calculation units 1166 and 1176 illustrated in FIGS. 32 and 33 instead of the simple data determination by the data determination units 1163 and 1173 and the comparison calculation units 1164 and 1174 illustrated in FIGS. 11 and 12 with the positive and negative signs.

As described above, the switching timing generation unit 153 according to Modification 1 executes the correlation calculation between the IQ complex signal of the SSS signal and the SSS sequence. Then, the switching timing generation unit 153 outputs the SSS index corresponding to the SSS sequence with the highest correlation value as NID1. Accordingly, even when there is the CPE, the switching timing generation unit 153 can detect the DL/UL switching timing.

### Second Embodiment

Next, a case where there is phase rotation will be considered.

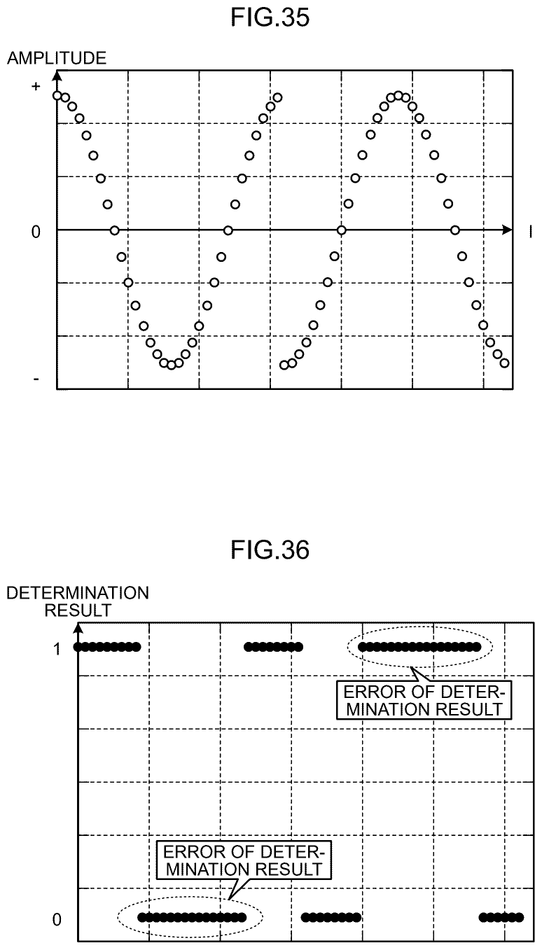

FIG. 34 is a diagram illustrating an example of a constellation when there is phase rotation. FIG. 35 is a diagram illustrating an example of an I-axis signal when there is phase rotation. FIG. 36 is a diagram illustrating an example of a data determination result when there is phase rotation.

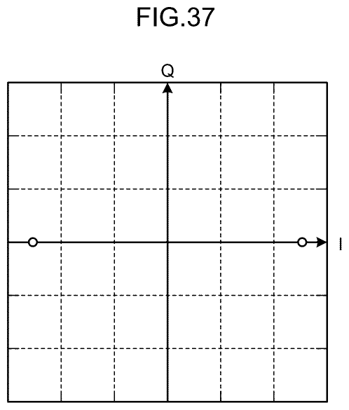

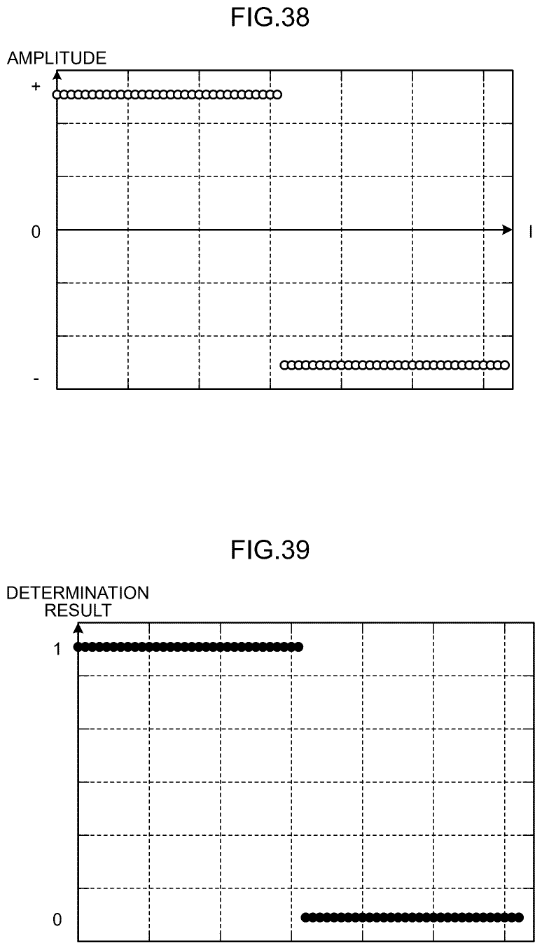

Moreover, FIG. 37 is a diagram illustrating an example of a constellation in a case where there is no phase rotation. FIG. 38 is a diagram illustrating an example of an I-axis signal when there is no phase rotation. FIG. 39 is a diagram illustrating an example of a data determination result in a case where there is no phase rotation.

The transmission signal when there is the phase rotation illustrated in FIGS. 34, 35, and 36 is the same as the transmission signal in the case where there is no phase rotation illustrated in FIGS. 37, 38, and 39. Conversely, when performance of the synchronization processing or the waveform equalization processing is not sufficient, a signal in which the phase rotation remains is input to the data determination unit 1163 of the SSS detection unit 1016 illustrated in FIG. 11. When the data determination method is a method of determining “1” in a case where the I-axis signal has a positive value and determining “0” in a case where the I-axis signal has a negative value, the determination result is as illustrated in FIG. 36. As is clear from the comparison with FIG. 39, there is an error in a wide range of the determination result of the BPSK signal.

When there is the phase rotation in the IQ complex signal even in the case where the correlation calculation is used as illustrated in FIG. 32, the correlation value in the correlation calculation unit 1166 is suppressed by the rotation component. Therefore, detection accuracy in the NID1 detection unit 1165a becomes lowered. As described above, it is difficult to determine a BPSK signal when the IQ complex signal has phase rotation. Therefore, it is necessary to correct the phase rotation on an IQ complex plane before the data is determined. Therefore, it is necessary to precisely synchronize the sampling frequency and phase, the frequency and phase of a carrier wave, a symbol timing, and the like. At the same time, it is necessary to accurately estimate characteristics of the propagation path and correct an influence of the characteristics.

Processing becomes complicated to accurately execute the synchronization processing and the waveform equalization processing, and implementation of the device incur high cost. Further, there is a constraint of a time from reception of a signal to completion of SSB demodulation processing due to switching time definition of transmission and reception by a time division multiplexing scheme. Since the synchronization processing and the waveform equalization processing described above are also subject to this time constraint. As a result, in order to correct the phase rotation, it is necessary for each processing circuit of demodulation, synchronization, and waveform equalization to operate at a high speed, and the cost for implementing the device becomes higher.

On the other hand, a reception environment of the distributed antenna system 1 is stable, compared with a reception environment of a general mobile phone, and quality of a reception signal is also good. It is not necessary to demodulate all the data being transmitted as long as only the data necessary for switching between transmission and reception can be demodulated. From the above, there is a potential demand for avoiding high cost for synchronization processing and waveform equalization processing.

Therefore, in a master station device 10 according to the second embodiment, phase rotation countermeasures are taken.

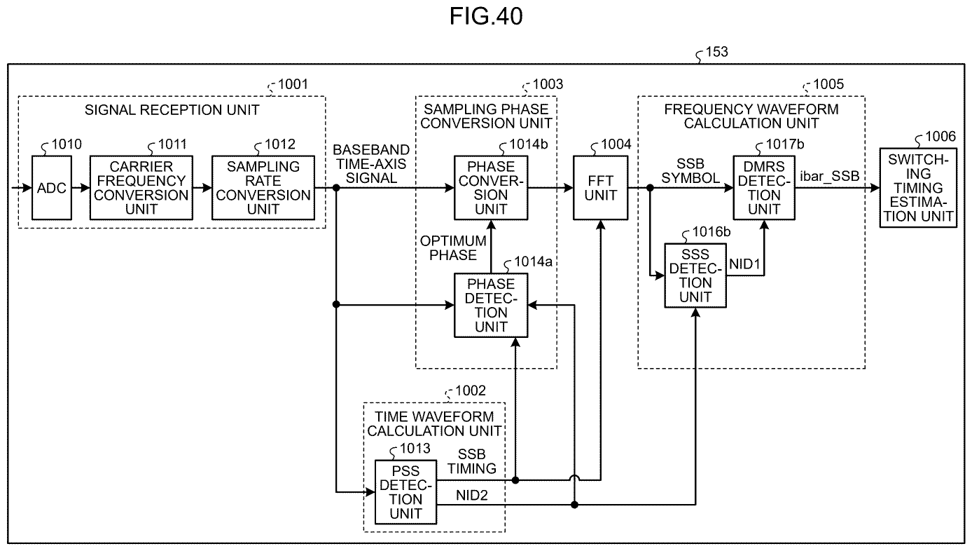

FIG. 40 is a diagram illustrating an example of a functional configuration of the switching timing generation unit 153 according to the second embodiment. When FIG. 40 is compared with FIG. 7, output of the FFT unit 1004 is input to the waveform equalization unit 1015 in FIG. 7. However, the frequency waveform calculation unit 1005 illustrated in FIG. 40 does not include the waveform equalization unit 1015 of the frequency waveform calculation unit 1005 illustrated in FIG. 7. The output of the FFT unit 1004 is directly input to an SSS detection unit 1016b and a DMRS detection unit 1017b. Accordingly, while cost related to the waveform equalization processing is reduced, the SSS detection unit 1016b and the DMRS detection unit 1017b are more considerably affected by an amplitude variation and a phase variation on a propagation path.

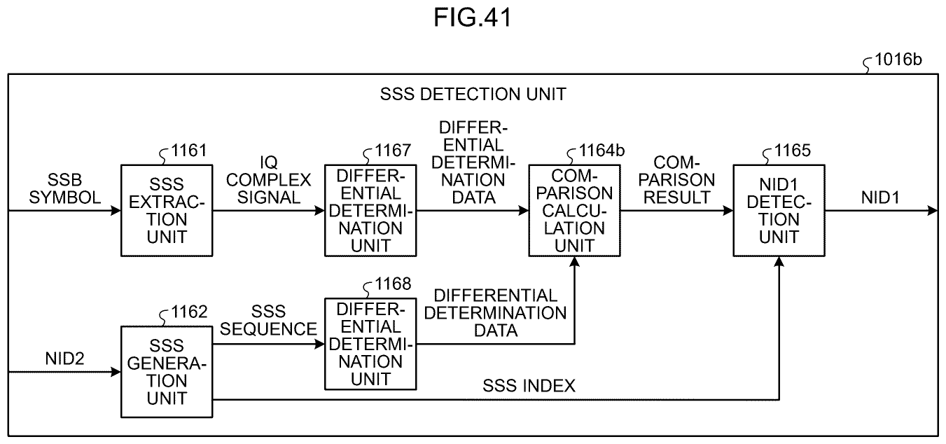

FIG. 41 is a diagram illustrating an example of a functional configuration of the SSS detection unit 1016b according to the second embodiment. Here, constituents having the same functions as those of the SSS detection unit 1016 illustrated in FIG. 11 are denoted by the same reference numerals, description thereof will be omitted, and only constituents having different functions will be described.

A differential determination unit 1167 extracts two signals at a predetermined interval from an IQ complex signal of the SSS signal that is output of the SSS extraction unit 1161, determines demodulated data corresponding to an IQ complex coordinate position, and outputs differential determination data (an example of the first differential determination data) indicating whether there is a difference between the obtained two pieces of demodulated data. The differential determination unit 1167 is an example of a first differential determination unit. More specifically, the differential determination unit 1167 extracts two pieces of demodulated data at a predetermined interval from the IQ complex signal of the SSS signal input from the SSS extraction unit 1161. The differential determination unit 1167 determines whether there is a difference between two pieces of demodulated data corresponding to the IQ complex coordinate position. Then, the differential determination unit 1167 outputs the differential determination data indicating whether there is a difference between the two pieces of demodulated data to a comparison calculation unit 1164b.

A differential determination unit 1168 extracts two signals at a predetermined interval from the input SSS sequence. Then, the differential determination unit 1168 outputs differential determination data (an example of the second differential determination data) indicating whether there is a difference between the two extracted values to the comparison calculation unit 1164b. The differential determination unit 1167 is an example of a second differential determination unit.

The comparison calculation unit 1164b compares the differential determination data from the differential determination unit 1167 with the differential determination data from the differential determination unit 1168, and outputs the number of matches indicating the number of matches of the data to the NID1 detection unit 1165 as a comparison result. The comparison calculation unit 1164b is an example of a second comparison calculation unit.

The NID1 detection unit 1165 determines the highest number of matches in the comparison result that is output of the comparison calculation unit 1164b. Then, the NID1 detection unit 1165 outputs the SSS index corresponding to the SSS sequence with the highest number of matches as NID1 indicating the group of cell identifiers of the physical layer. The NID1 detection unit 1165 is an example of a third NID1 detection unit.

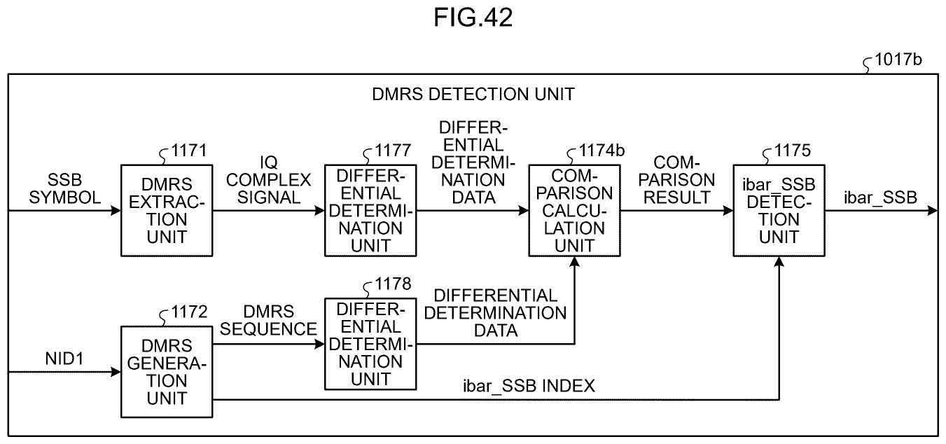

FIG. 42 is a diagram illustrating an example of a functional configuration of the DMRS detection unit 1017b according to the second embodiment. Here, constituents having the same functions as those in FIG. 12 will be denoted by the same reference numerals, the description thereof will be omitted, and only constituents having different functions will be described.

A differential determination unit 1177 extracts two signals at a predetermined interval from the IQ complex signal of the DMRS signal that is output of the DMRS extraction unit 1171, determines demodulated data corresponding to the IQ complex coordinate position, and outputs differential determination data (an example of the third differential determination data) indicating whether there is a difference between the obtained two pieces of demodulated data. The differential determination unit 1177 is an example of a third differential determination unit. More specifically, the differential determination unit 1177 extracts two pieces of demodulated data at a predetermined interval from the IQ complex signal of the input DMRS signal. The differential determination unit 1177 determines whether there is a difference between the two pieces of demodulated data corresponding to the IQ complex coordinate position. Then, the differential determination unit 1177 outputs the differential determination data indicating whether there is a difference between the two demodulated data to a comparison calculation unit 1174b.

A differential determination unit 1178 extracts two signals at a predetermined interval from the input DMRS sequence. Then, the differential determination unit 1178 outputs differential determination data (an example of the fourth differential determination data) indicating whether there is a difference between the two extracted values to the comparison calculation unit 1174b. The differential determination unit 1178 is an example of a fourth differential determination unit.

The comparison calculation unit 1174b compares the differential determination data from the differential determination unit 1177 with the differential determination data from the differential determination unit 1178. Then, the comparison calculation unit 1174b outputs, as a comparison result, the number of matches of the data to the ibar_SSB detection unit 1175. The comparison calculation unit 1174b is an example of a fourth comparison calculation unit.

The ibar_SSB detection unit 1175 determines the highest number of matches in the comparison result that is output of the comparison calculation unit 1174b. Then, the ibar_SSB detection unit 1175 outputs, as ibar_SSB, the ibar_SSB index corresponding to the DMRS sequence with the highest number of matches. The ibar_SSB detection unit 1175 is an example of a third ibar_SSB detection unit.

In such a configuration, demodulation of the SSB symbol when there is no phase rotation, when there is the CPE, and when there is the phase rotation in the master station device 10 according to the second embodiment will be described.

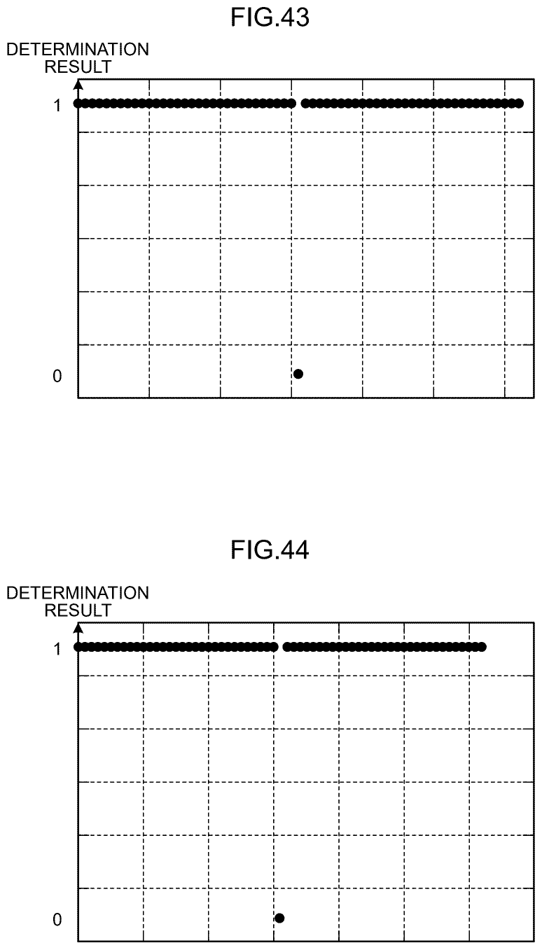

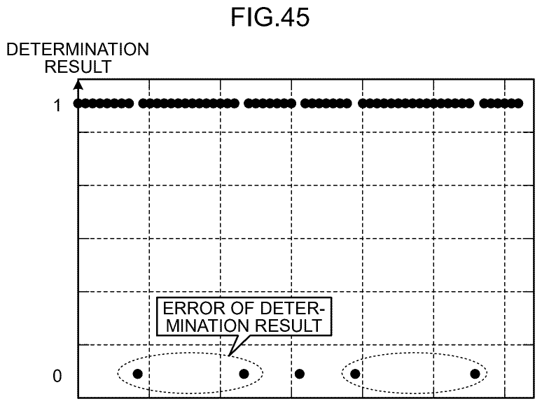

FIG. 43 is a diagram illustrating an example of a differential determination result when there is no phase rotation. FIG. 44 is a diagram illustrating an example of a differential determination result when there is CPE. FIG. 45 is a diagram illustrating an example of a differential determination result when there is phase rotation.

First, a case where there is no phase rotation will be described.

As an example of an SSB symbol subjected to binary phase shift keying (BPSK), a case where the signals in FIGS. 37 and 38 with no phase rotation described above are input to the differential determination unit 1167 of the SSS detection unit 1016 in FIG. 41 will be described. As the differential determination, for example, focusing on a certain I-axis signal and an adjacent I-axis signal, when positive and negative signs of the certain I-axis signal and the adjacent I-axis signal match each other, “1” is determined. When the positive and negative signs do not match each other, “0” is determined. Then, a determination result is illustrated in FIG. 43. In FIG. 38, since the positive and negative signs do not match between two adjacent pieces of data only in a set of data near the center across the I axis, only the center of the differential determination result is determined as “0”, and the other is determined as “1”. The determination result in the differential determination unit 1168 is also the same as that in FIG. 43.

Accordingly, in the comparison calculation unit 1164b, the number of matches is highest when the differential determination data from the differential determination unit 1167 and the differential determination data from the differential determination unit 1168 are the same. The NID1 detection unit 1165 outputs the SSS index corresponding to the SSS sequence at that time as NID1.

Next, a case where there is the CPE described above will be described.

The cases of FIGS. 29 and 30 will be described as an example. The transmission signal is the same as when there is no phase rotation described above.

However, the signal in which the CPE remains is input to the differential determination unit 1167 of the SSS detection unit 1016 illustrated in FIG. 41 according to performance of the synchronization processing and the waveform equalization processing. As the differential determination, when the positive and negative signs of a certain I-axis signal and an adjacent I-axis signal match each other, “1” is determined. When the positive and negative signs do not match each other, “0” is determined. A determination result is illustrated in FIG. 44. The determination result is the same as that in FIG. 43, and a determination error does not occur. Accordingly, it can be understood that a problem due to the CPE is solved not only in the modification of the first embodiment described above but also in the second embodiment.

Next, a case of FIGS. 34 and 35 where there is the above-described phase rotation will be described as an example. The transmission signal is the same as that when there is no phase rotation described above. However, a signal in which the phase rotation remains is input to the differential determination unit 1167 of the SSS detection unit 1016 illustrated in FIG. 41 according to performance of the synchronization processing or the waveform equalization processing. As the differential determination, when the positive and negative signs of a certain I-axis signal and an adjacent I-axis signal match each other, “1” is determined. When the positive and negative signs do not match each other, “0” is determined. The determination result is illustrated in FIG. 45.

In the I-axis signal of FIG. 35, there are five locations that cross the I-axis between two adjacent pieces of data, and the positive and negative signs of two pieces of data are the same at other locations. Therefore, when the differential determination is executed on this signal, “0” is determined at five points, and “1” is determined at the other locations, as illustrated in FIG. 45. On the other hand, the determination result in the differential determination unit 1168 is the same as that in FIG. 43 in which there is no phase rotation, and one location is determined as “0”, and the others are determined as “1”. Accordingly, the number of errors of the determination result is four. In the first embodiment and Modification 1 described above, as illustrated in FIG. 36, an error occurs in a wide range of the determination result. In the second embodiment, the determination error is limited. As a result, detection accuracy in the NID1 detection unit 1165 can be improved.

As described above, the switching timing generation unit 153 according to the first embodiment extracts two signals at a predetermined interval from the IQ complex signal of the SSS signal, and generates differential determination data indicating whether there is a difference between two pieces of demodulated data corresponding to the IQ complex coordinate position. The switching timing generation unit 153 extracts two signals at a predetermined interval from the SSS sequence, and generates differential determination data indicating whether there is a difference between the two pieces of extracted demodulated data. Then, the switching timing generation unit 153 compares the two pieces of differential determination data, and outputs, as NID1, the SSS index corresponding to the SSS sequence with the highest number of matches.

Accordingly, the switching timing generation unit 153 can detect the DL/UL switching timing in any of the case where there is no phase rotation, the case where there is the CPE, and the case where there is the phase rotation.

A program executed by the master station device 10 according to the present embodiment is a file in an installable format or an executable format, and is provided by being recorded in a computer-readable recording medium such as a semiconductor storage device such as a digital versatile disk (DVD), a universal serial bus (USB) memory, or a solid state drive (SSD).

The program may be stored on a computer connected to a network such as the Internet and may be provided by being downloaded via the network. The program may be provided or distributed via a network such as the Internet.

The program may be provided by being embedded in a ROM or the like in advance.

### REFERENCE SIGNS LIST

1 . . . distributed antenna system
10 . . . master station device (MU)
11 . . . upper input/output unit
12 . . . lower input/output unit
13 . . . downlink processing unit
14 . . . uplink processing unit
15 . . . control unit
20 . . . relay device (HU)
30 . . . slave station device (RU)
40 . . . transmission path
50 . . . base station
60 . . . terminal device
70 . . . antenna
153 . . . switching timing generation unit
154 . . . switching unit
1001 . . . signal reception unit
1002 . . . time waveform calculation unit
1003 . . . sampling phase conversion unit
1004 . . . Fast Fourier Transform (FFT) unit
1005 . . . frequency waveform calculation unit
1006 . . . switching timing estimation unit
1010 . . . ADC unit
1011 . . . carrier frequency conversion unit
1012 . . . sampling rate conversion unit
1013 . . . PSS detection unit
1014a . . . phase detection unit
1014a1 . . . data holding unit
1014a2 . . . phase conversion unit
1014a3 . . . PSS code sequence selection unit
1014a4 . . . correlation calculation unit
1014a5 . . . phase determination unit
1014b . . . phase conversion unit
1014b1 . . . filter coefficient selection unit
1014b2 . . . filter operation unit
1015 . . . waveform equalization unit
1016, 1016a, 1016b . . . SSS detection unit
1017, 1017b . . . DMRS detection unit
1131 . . . time signal extraction unit
1132 . . . PSS generation unit
1133, 1166, 1176 . . . correlation calculation unit
1134 . . . NID2 detection unit
1161 . . . SSS extraction unit
1162 . . . SSS generation unit
1163 . . . data determination unit
1164, 1164b . . . comparison calculation unit
1165, 1165a . . . NID1 detection unit
1166 . . . correlation calculation unit
1167, 1168, 1177, 1178 . . . differential determination unit
1171 . . . DMRS extraction unit
1172 . . . DMRS generation unit
1173 . . . data determination unit
1174, 1174b . . . comparison calculation unit
1175, 1175a . . . ibar_SSB detection unit

1. A communication device functioning as a master station device or a slave station device in a distributed antenna system and receiving an orthogonal frequency division multiplexing (OFDM) signal transmitted by a time division multiplexing scheme, the distributed antenna system including the master station device connected to a base station and one or more slave station devices relaying a signal between the master station device and a terminal device communicating with the base station, the communication device comprising:
a hardware processor connected to a memory and configured to:
receive the OFDM signal and convert the OFDM signal into a baseband time-axis waveform signal;
extract a part of the time-axis waveform signal;
calculate a degree of similarity between the extracted part of the time-axis waveform signal and a known signal;
convert a sampling phase of the time waveform signal based on the degree of similarity;
execute fast Fourier transform (FFT) on the time-axis waveform signal whose sampling phase has been converted;
extract a part of a frequency-axis waveform signal obtained by the FFT;
calculate a degree of similarity between the extracted part of the frequency-axis waveform signal and a known signal; and
estimate a switching timing between uplink communication and downlink communication in the communication device based on the degree of similarity.

2. The communication device according to claim 1, wherein the hardware processor is further configured to receive a radio frame including a synchronization signal block (SS/PBCH; SSB) that includes a primary synchronization signal (PSS), a secondary synchronization signal (SSS), and a physical broadcast channel (PBCH) including a demodulation of reference signal (DMRS).

3. The communication device according to claim 2, wherein the hardware processor is further configured to detect a PSS signal included in the time-axis waveform signal.

4. The communication device according to claim 3, wherein the hardware processor is further configured to:
extract a part of the time-axis waveform signal,
generate PSS code sequences of the PSS signal and code sequence numbers for identifying the PSS code sequences,
execute correlation calculation between the extracted time-axis waveform signal and the PSS code sequence
to calculate a correlation value,
detect, as an SSB timing, a timing at which the correlation value is highest in a predetermined time range, and
detect, as NID2 being a cell identifier of a physical layer, a PSS code sequence number corresponding to the PSS code sequence at which the correlation value is highest.

5. The communication device according to claim 4, wherein the hardware processor is further configured to:
detect an optimum phase at which a sampling phase of the time-axis waveform signal is best, the optimum phase being detected based on the SSB timing and the physical layer cell identifier NID2, and
convert a sampling phase of the time-axis waveform signal based on the optimum phase.

6. The communication device according to claim 5, wherein the hardware processor is further configured to:
hold a part of the time-axis waveform signal based on the SSB timing,
convert a sampling phase into a plurality of predetermined phases with respect to the time-axis waveform signal held,
select one of the PSS code sequences based on the physical layer cell identifier NID2,
calculate a correlation value between each of the time-axis waveform signals whose sampling phase has been converted and the selected PSS code sequence, and
determine a time-axis waveform signal most similar to the PSS code sequence based on the correlation values, and
determine, as the optimum phase, an sampling phase of the time-axis waveform signal determined.

7. The communication device according to claim 6, wherein the hardware processor is further configured to:
a select one of filter coefficients based on the optimum phase, and
convert a sampling phase of the time-axis waveform signal based on the selected filter coefficient.

8. The communication device according to claim 1, wherein the hardware processor is further configured to correct at least one of amplitude or phase distortion on an IQ complex plane with respect to the frequency-axis waveform signal.

9. The communication device according to claim 3, wherein the hardware processor is further configured to detect an SSS signal included in the frequency-axis waveform signal.

10. The communication device according to claim 9, wherein the hardware processor is further configured to detect a DMRS signal included in the frequency-axis waveform signal.

11. The communication device according to claim 9, wherein the hardware processor is further configured to:
extract, from the frequency-axis waveform signal, a frequency component in which an SSS signal is placed, and
generate first SSS sequences corresponding to NID2 being a cell identifier of a physical layer, and
generate SSS indices for identifying the first SSS sequences.

12. The communication device according to claim 11, wherein the hardware processor is further configured to:
determine demodulated data corresponding to an IQ complex coordinate position of the SSS signal,
generate, as a second SSS sequence, a series of data determined over the entire SSS signal,
compare the second SSS sequence with the first SSS sequence,
generate a comparison result indicating the number of matches of values,
determine a comparison result indicating the highest number of matches among comparison results, and
detect, as NID1, an SSS index corresponding to a first SSS sequence with the highest number of matches, the NID1 indicating a group of cell identifiers of the physical layer.

13. The communication device according to claim 11, wherein the hardware processor is further configured to:
execute a correlation calculation between an IQ complex signal of the SSS signal and the first SSS sequence,
determine a correlation result indicating the highest correlation value among correlation results of the correlation calculation, and
detect, as NID1, an SSS index corresponding to a first SSS sequence with the highest correlation value, the NID1 indicating a group of cell identifiers of the physical layer.

14. The communication device according to claim 11, wherein the hardware processor is further configured to:
extract two signals at a predetermined interval from an IQ complex signal of the SSS signal,
determine demodulated data corresponding to an IQ complex coordinate position,
generate first differential determination data indicating whether there is a difference between two pieces of obtained demodulated data,
extract two values at a predetermined interval from the first SSS sequence,
generate second differential determination data indicating whether there is a difference between the extracted two values,
compare the first differential determination data with the second differential determination data,
generate a comparison result indicating the number of matches of data,
determine a comparison result indicating the highest number of matches among comparison results, and
detect, as NID1, an SSS index corresponding to a first SSS sequence with the highest number of matches, the NID1 indicating a group of the cell identifiers of the physical layer.

15. The communication device according to claim 10, wherein the hardware processor is further configured to:
extract a frequency component in which a DMRS signal is placed from the frequency-axis waveform signal, and
generate first DMRS sequences corresponding to NID1 and ibar_SSB indices for identifying the first DMRS sequences, the NID1 indicating a group of cell identifiers of a physical layer.

16. The communication device according to claim 15, wherein hardware processor is further configured to:
determine demodulated data corresponding to an IQ complex coordinate position of the DMRS signal,
generate, as a second DMRS sequence, a series of data determined over the entire DMRS signal,
compare the second DMRS sequence with the first DMRS sequence,
generate a comparison result indicating the number of matches of values,
determine a comparison result indicating the highest number of matches among comparison results, and
detect an ibar_SSB index corresponding to a first DMRS sequence with the highest number of matches.

17. The communication device according to claim 15, wherein the hardware processor is further configured to:
execute correlation calculation between an IQ complex signal of the DMRS signal and the first DMRS sequence,
determine a correlation result indicating the highest correlation value among correlation results of the correlation calculation unit, and
detect an ibar_SSB index corresponding to a first DMRS sequence with the highest correlation value.

18. The communication device according to claim 15, wherein the hardware processor is further configured to:
extract two signals at a predetermined interval from an IQ complex signal of the DMRS signal,
determine demodulated data corresponding to an IQ complex coordinate position,
generate third differential determination data indicating whether there is a difference between the two pieces of obtained demodulated data,
extract two values at a predetermined interval from the first DMRS sequence,
generate fourth differential determination data indicating whether there is a difference between the extracted two values,
compare the third differential determination with the fourth differential determination data,
generate a comparison result indicating the number of matches of data,
determine a comparison result indicating the highest number of matches among comparison results, and
detect an ibar_SSB index corresponding to a first DMRS sequence with the highest number of matches.

19. A control method of a communication device, the communication device functioning as a master station device or a slave station device in a distributed antenna system and receiving an orthogonal frequency division multiplexing (OFDM) signal transmitted by a time division multiplexing scheme, the distributed antenna system including the master station device connected to a base station and one or more slave station devices relaying a signal between the master station device and a terminal device communicating with the base station, the method comprising:
receiving the OFDM signal and converting the OFDM signal into a baseband time-axis waveform signal;
extracting a part of the time-axis waveform signal and calculating a degree of similarity between the extracted signal and a known signal;
converting a sampling phase of the time waveform signal as the OFDM signal based on the degree of similarity to a known signal calculated;
executing fast Fourier transform (FFT) on the time-axis waveform signal obtained by the converting the sampling phase;
extracting a part of a frequency-axis waveform signal on which the FFT is executed and calculating a degree of similarity between the extracted signal and a known signal; and
estimating a switching timing between uplink communication and downlink communication in the communication device based on a result of the calculating the degree of similarity.

20. A non-transitory recording medium on which a computer program causing a computer to implement the control method according to claim 19 is stored, the computer serving as the communication device.
